(19) United States
(12) Patent Application Publication
(10) Pub. No.: US 2024/0301198 A1
(43) Pub. Date: Sep. 12, 2024

(54) Urea Formaldehyde Resin Compositions, Methods of Making, and Uses Thereof

(71) Applicant: Hexion Inc., Columbus, OH (US)

(72) Inventors: Byung Young NO, Springfield, OR (US); Gregory D. BRINER, Springfield, OR (US); Alan Kirk EDWARDS, Morganton, NC (US); David A. SNOVER, Morganton, NC (US)

(21) Appl. No.: 18/119,687

(22) Filed: Mar. 9, 2023

(51) Int. Cl. C08L 61/32

(52) U.S. Cl. CPC C08L 61/32; C08L 2205/03

(57) ABSTRACT

Embodiments of the present disclosure generally relate to urea-formaldehyde (UF) resin compositions, methods of making, and uses thereof. In an embodiment, a method of forming a UF resin composition is provided. The method includes heating a first mixture comprising formaldehyde and a first amount of urea, introducing a bio-additive with the first mixture to from a second mixture, and heating the second mixture at a selected temperature while maintaining the second mixture at a selected pH. The method further includes introducing a second amount of urea to the second mixture to form a third mixture, and heating the third mixture to form a first product mixture comprising a UF resin composition. In another embodiment, a UF resin composition is provided. The UF resin composition includes a liquid UF resin and a bio-additive. The UF resin composition can optionally include a rheology- and/or strength-enhancing polymer, a methylated melamine-formaldehyde crosslinker, or both.

### FIELD

Embodiments of the present disclosure generally relate to urea-formaldehyde resin compositions, to methods of making urea-formaldehyde resin compositions, and to uses of urea-formaldehyde resin compositions.

### BACKGROUND

Urea-formaldehyde (UF) resins are utilized as, for example, binder compositions for fibrous materials, such as glass fibers, to form glass fiber mats. The glass fiber mats are useful in the manufacture of a variety of building and construction industry products such as insulation, siding, and roofing shingles. UF resins have been used for these products due to their low cost, fast cure speed, and good cure strength. UF resins can be advantageous for use as binder compositions in building and construction industry products because of low cost, quick cure, and high strength per weight response. Relative to modified UF resins, unmodified UF resins can have lower dry tensile values, lower web strength, lower tear strength, and lower flexibility.

Conventional technologies modify UF resins with, for example, latex to increase strength, toughness, and flexibility. The latex modifiers can enhance mat properties such as wet and dry tensile strengths, when compared to non-latex modified UF resins. However, the use of latex modifiers increases process time and product cost. Further, adding latex to the UF resins decreases the tear strength property of the resultant glass fiber mat. In addition, the UF binder resins and the latex used for the production of glass fiber mats are synthetic, petroleum-based materials.

There is a need for new and improved urea-formaldehyde resin compositions and to articles that include urea-formaldehyde resin compositions. There is also a need for improved methods of making urea-formaldehyde resin compositions.

### SUMMARY

Embodiments of the present disclosure generally relate to urea-formaldehyde resin compositions, to methods of making urea-formaldehyde resin compositions, and to uses of urea-formaldehyde resin compositions. Unlike conventional technologies, urea-formaldehyde resin compositions of the present disclosure can be free of latex. Urea-formaldehyde resin compositions described herein can have improved storage stability and three-hour white-water dilution compatibility relative to conventional urea-formaldehyde resin compositions. In addition, urea-formaldehyde resin compositions described herein can be characterized as being more sustainable than conventional urea-formaldehyde resin compositions as embodiments described herein can include bio-additives. When used in articles of manufacture such as glass mats, urea-formaldehyde resin compositions described herein have, for example, improved mechanical properties than conventional urea-formaldehyde resin compositions such as those containing latex.

In an embodiment, a method of forming a urea-formaldehyde resin composition is provided. The method includes heating a first mixture comprising formaldehyde and a first amount of urea, introducing a bio-additive with the first mixture to from a second mixture, and heating the second mixture at a selected temperature while maintaining the second mixture at a selected pH. The method further includes introducing a second amount of urea to the second mixture to form a third mixture, and heating the third mixture to form a first product mixture comprising a urea-formaldehyde resin composition.

In another embodiment, a method of forming a urea-formaldehyde resin composition is provided. The method includes heating a first mixture comprising formaldehyde and a first amount of urea, the first mixture comprising a reaction molar ratio of the formaldehyde to the first amount of urea (F:U1) of about 2:1 to about 4:1. The method further includes introducing a bio-additive with the first mixture to from a second mixture; and heating the second mixture comprising the bio-additive and the first mixture at a temperature of about 70° C. to about 95° C. while maintaining the second mixture at a pH of about 7 to about 9. The method further includes introducing a second amount of urea to the second mixture to form a third mixture, the third mixture having a final molar ratio of the formaldehyde to a total amount of first urea and second urea (F:U1+U2) of about 0.7:1 to about 2.4:1. The method further includes heating the third mixture to form a first product mixture comprising a first urea-formaldehyde resin composition.

In another embodiment, a urea-formaldehyde resin composition is provided. The urea-formaldehyde resin composition includes a urea-formaldehyde resin and a bio-additive. The urea-formaldehyde resin composition can optionally include a rheology- and/or strength-enhancing polymer, a methylated melamine-formaldehyde crosslinker, or both.

In another embodiment, a urea-formaldehyde resin composition is provided. The urea-formaldehyde composition includes a liquid urea-formaldehyde resin. The urea-formaldehyde resin composition further includes greater than 0 wt % and 7 wt % or less of a bio-additive based on a total wt % of the urea-formaldehyde resin composition, the bio-additive comprising starch, guar gum, xantham gum, flour, a cationic derivative thereof, an anionic derivative thereof, a zwitterionic derivative thereof, a non-ionic derivative thereof, or combinations thereof.

In another embodiment, an article is provided. The article includes a substrate. The article further includes a urea-formaldehyde resin composition to adhere the substrate together into the article, the urea-formaldehyde resin composition comprising: a urea-formaldehyde resin and a bio-additive. The urea-formaldehyde resin composition of the article can optionally include a rheology- and/or strength-enhancing polymer, a methylated melamine-formaldehyde crosslinker, or both.

In another embodiment, an article is provided. The article includes a substrate. The article further includes a urea-formaldehyde resin composition to adhere the substrate together into the article, the urea-formaldehyde resin composition comprising: a liquid urea-formaldehyde resin; and greater than 0 wt % and 7 wt % or less of a bio-additive based on a total wt % of the urea-formaldehyde resin composition, the bio-additive comprising starch, guar gum, xantham gum, flour, a cationic derivative thereof, an anionic derivative thereof, a zwitterionic derivative thereof, a non-ionic derivative thereof, or combinations thereof

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 shows exemplary gel permeation chromatography (GPC) data for two urea-formaldehyde (UF) resin compositions comprising starch made using different reaction processes according to at least one embodiment of the present disclosure.

FIG. 2 shows exemplary GPC data for three example UF resin compositions comprising varying amounts of starch and a control UF resin according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to urea-formaldehyde resin compositions, to methods of making urea-formaldehyde resin compositions, and to uses of urea-formaldehyde resin compositions. Unlike conventional technologies which utilize latex or other petroleum-based materials, urea-formaldehyde (UF) resin compositions described herein include a bio-additive. Use of a bio-additive can, for example, improve strength properties of articles made with UF resin compositions such as glass fiber mats, while at the same time, contribute to sustainability. Moreover, bio-additives can be lower in cost relative to latex materials, such that use of bio-additives can lower production costs.

UF resin compositions described herein can comprise, consist essentially of, or consist of a liquid urea-formaldehyde resin, a bio-additive, and one or more optional components. The one or more optional components can include a modifier (such as rheology enhancing polymers, strength enhancing polymers, or combinations thereof), a methylated melamine-formaldehyde (MMF) crosslinker, or combinations thereof, among other additives.

UF resin compositions described herein can be storage stable. As a result, UF resin compositions described herein can be single component systems (1K systems). 1K systems already comprise all of the necessary ingredients and are stable in storage. It is also contemplated that compositions described herein are suitable as a storable component for a 2K system or other multi-component system.

Some conventional, thermosetting urea-formaldehyde (UF) binder formulations include a urea-formaldehyde resin, thickener, surfactant, and water. The thickeners can be made from additives such as polysaccharides. Here, the polysaccharides are used as a thickener to mix with the pre-made UF control resin. Other conventional technologies utilize starch (at amounts of 1-10 wt %) in methods for producing a UF binder formulation, and such binder formulations are used to make fiber reinforced composites. Such conventional methods use the starch to mix with a pre-made commercial UF resins.

In contrast, the inventors of the present disclosure discovered methods that include reaction stage(s). The reaction stage(s) can, for example, enable control, selection, or targeting of bio-additives of certain molecular weights or molecular weight ranges. That is, the molecular weight of the bio-additive can be controlled, selected, or targeted by different reaction stages. As further described below, the higher molecular weight region of starch (as an example bio-additive) can be changed or eliminated dependent upon the reaction synthesis method. Dependent upon, for example, the reaction time and reaction temperature, the dissolution of starch (or another bio-additive) can be different leading to UF resin compositions having beneficial viscosity properties and little-to no phase separation.

In some embodiments, the reaction stage(s) can enable control, selection, or targeting of other components that are added during methods described herein such as rheology enhancing polymers and strength enhancing polymers. Reaction stage(s) can also modify the rheology of the resultant UF resin compositions during the UF manufacturing process.

Properties of the resultant UF resin compositions described herein are also improved relative to conventional technologies. For example, the surface tension of UF resin compositions described herein (for example, above about 51 mN/m) are higher than surface tension values of conventional UF binder formulations. Further, UF resin compositions of the present disclosure can, for example, improve the wet web strength of the wet glass-fiber mat as well as the mechanical strength of the cured glass-fiber mat. Here, the web strength during wet processing and the mechanical strength of the cured glass-fiber mat are increased. UF resin compositions of the present disclosure can also show excellent storage stability and white water stability.

Another conventional method uses a water-soluble carbamide-aldehyde reaction product to prepare modified starch pastes. In contrast, embodiments described herein can be utilized to synthesize UF polymers with starch during a reaction process.

Some conventional fiber mat products are made using aqueous binders containing a blend of a commercial urea formaldehyde and commercial melamine formaldehyde. In contrast, embodiments described herein can include use of a methylated melamine formaldehyde crosslinker to react with bio-additives modified UF polymers during a reaction process.

Overall, conventional technologies fail to, at least, provide good alternatives to latex modifiers of UF resins. In contrast, embodiments described herein can enable formation of UF resin compositions with good mechanical strength, web strength during processing, and storage stability. Unlike conventional technologies, UF resin compositions described herein can include a bio-additive, a modifier (for example, rheology enhancing polymers, strength enhancing polymers, or combinations thereof), a methylated melamine-formaldehyde (MMF) crosslinker, or combinations thereof, among other additives. Further, UF resin compositions described herein can be used to manufacture articles, such as glass mats, having better mechanical strength properties than those mats made with commercially available UF resins. In addition, embodiments described herein can enable formation of UF resins having improved storage stability and water stability/dilutability, as well as improved properties when used in articles of manufacture such as improving the adhesion of glass fibers and improving the wet-web process strength of glass mats.

The use of headings is for purposes of convenience only and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

Embodiments described herein include preparation of UF resin compositions that include one or more reaction stages. As used herein, the term “reaction stage” refers to stages or phases during a process for preparing a UF resin composition during which at least two reactants—e.g., urea, formaldehyde, bio-additives, methylated melamine-formaldehyde crosslinker, among others—are being condensed and/or incorporated into the reaction mixture (chemically and/or physically).

As used herein, the term “reacted-in” refers to the incorporation or inclusion, which can be chemically and/or physically, of a material in the reaction mixture at an elevated temperature for a specified reaction operation).

It should be noted that there may be two types of molar ratios described in this disclosure, for example, a “reaction” molar ratio and a “final” molar ratio. The reaction molar ratio is the ratio of formaldehyde to urea compounds (and sometimes ammonia) that is present during a condensation or reaction. Typically, these reactants are, subject to stoichiometric limits, substantially all incorporated into a polymer. The final molar ratio includes both the reactants that were present during the condensation or reaction and any urea and/or ammonia compounds that may have been added after the condensation or reaction. While these later added compounds may not be immediately incorporated into a polymer backbone, they are present within the resin and may, over time, “cure” into the polymer.

For the purposes of the disclosure, the term cure means to interact with other compounds within a resin to produce a solid thermoset binding material.

### Urea-Formaldehyde Resin Compositions

Embodiments of the present disclosure relate to urea-formaldehyde resin compositions. UF resin compositions described herein can comprise, consist essentially of, or consist of a liquid urea-formaldehyde resin, a bio-additive, and one or more optional components. The one or more optional components can include a modifier (such as rheology-enhancing polymers, strength-enhancing polymers, or combinations thereof), a MMF crosslinker, or combinations thereof, among other additives.

Urea-formaldehyde resin compositions can be curable compositions wherein the compositions can be cured by application of a stimulus, for example, a change in temperature. The curable urea-formaldehyde resin composition can be a 1K system. It is also contemplated that urea-formaldehyde resin compositions described herein are suitable as a storable component for a 2K system or other multi-component system.

UF resin compositions of the present disclosure include a UF resin. The UF resin can be solid or liquid. As used herein, a “liquid urea-formaldehyde resin” (or a “liquid UF resin”) can include component(s) utilized to form the UF resin, reaction product(s) of two or more components utilized to form the UF resin, a remainder balance of remaining starting component(s) urea-formaldehyde resin, or combinations thereof. For example, a liquid urea-formaldehyde resin (or liquid UF resin) takes into account the urea-formaldehyde resin, free (or unreacted) urea, free (or unreacted) formaldehyde, water, among other components. In addition, an amount (wt %) of a liquid urea-formaldehyde resin takes into account the urea-formaldehyde resin, free (or unreacted) urea, free (or unreacted) formaldehyde, water, among other components.

Although embodiments of the present disclosure may be described as including a urea-formaldehyde resin (without designation as to being in a liquid or solid state), it should be understood that embodiments apply to both liquid and solid urea-formaldehyde resins.

In some embodiments, liquid UF resins may be prepared using formalin which is, for the purposes of this disclosure, formaldehyde dissolved in water. Any suitable concentration of formaldehyde in the formalin can be used, such as a weight concentration of about 35 weight percent (wt %) to about 60 wt %, such as from about 40 wt % to about 55 wt %, such as from about 45 wt % to about 50 wt %, or from about 44 wt % to about 55 wt %, or about 35 wt %, or about 50 wt %. Any of the foregoing numbers can be used singly to describe an open-ended range or in combination to describe a close-ended range. Other concentrations are contemplated.

Additionally, or alternatively, liquid UF resins described herein can be prepared using formaldehyde in the form of a urea-formaldehyde concentrate. This concentrate can include, for example, about 60% formaldehyde and about 25% urea, though other urea formaldehyde concentrates can be utilized.

Liquid UF resins of the present disclosure can be made with urea. The urea used with embodiments described herein can be any that is suitable. For example, the urea can be white solid granules having a purity of about 98 percent.

Liquid UF resins described herein can have lower ratios of formaldehyde to urea than resins prepared using conventional UF. While not wishing to be bound to any theory, it is believed that the reduced formaldehyde ratios can result in lower formaldehyde emissions from articles of manufacture prepared using UF resin compositions described herein.

UF resin compositions described herein can include a bio-additive. Bio-additives are materials of biological origin (a living organism) that may be modified or unmodified. Bio-additives can be derived from materials of biological origin, for example, the bio-additive may be altered, for example, physically, chemically, enzymatically, or combinations thereof. Bio-additives can include materials present in biomass. In this context, biomass refers to biological material that can be used in a resin composition. Illustrative, but non-limiting, examples of biomass include materials, by-products, and waste generated from, e.g., agricultural and forestry processes, such as agricultural matter and residues (e.g., wheat straw and corn), energy crops (e.g., wheatgrass and bamboo), forest residues (e.g., materials, by-products and waste from forest harvesting such as woodchips), plant- and algae-based matter and residues, and the like, and combinations thereof. In some embodiments, biomass includes wood, leaves, pulps, stalks, grass material, shrubs, branches, energy crops, vegetables, fruits, flowers, grains, herbaceous crops, bark, needles, logs, trees, and combinations thereof. Additionally, or alternatively, biomass includes municipal solid waste, by-products and waste from wood-processing, by-products and waste from papermaking or timber processes, by-products and waste from agricultural and forestry activities, rotation crops, lumber, wood chips, sawdust, straw, firewood, wood materials, paper, waste paper, yard waste, and the like. In some embodiments, biomass includes polysaccharides, polypeptides, or combinations thereof.

Bio-additives can be cationic, anionic, zwitterionic, or non-ionic. When a bio-additive is referred to as being “cationic”, the bio-additive includes a positively charged moiety such as a quaternary ammonium group among others. For example, cationic starch can include a positively charged moiety such as a quaternary ammonium group. When a bio-additive is referred to as being “anionic”, the bio-additive includes a negatively charged moiety such as a phosphate group, a sulfate group, a sulfocarboxylate group, a carboxylate group, a carboxyalkylate group, an alkenylsuccinylate group, among others. For example, cationic starch can include a negatively charged moiety such as a sulfate group. When a bio-additive is referred to as being “zwitterionic”, the bio-additive includes a negatively charged moiety and a positively charged moiety such as those described herein.

Starch can be utilized as a bio-additive. Different types of natural starches (non-treated starch) can be used a bio-additive, such as corn starch, potato starch, tapioca starch, arrowroot, wheat rice, among others. Also, different modified starches can be used, such as a cationic starch, an anionic starch, a zwitterionic starch, a nonionic starch, a carboxylated starch, among others. Other bio-additives useful include natural guar gum, cationic guar gum, anionic guar gum, natural xanthan gum, cationic xanthan gum, anionic xanthan gum, natural flours including different types of flours, natural soy flour (or soy protein), cationic soy flour (or cationic soy protein), anionic soy flour (or anionic soy protein), among others. Non-limiting examples of cationic starch include CATO 232 (Ingredion) and Sta-Lok 120 (Primient).

Starches useful for embodiments described herein can include about 70 wt % or more of amylopectin and about 30 wt % or less of amylose. In some embodiments, the starch can include amylopectin in an amount that is from about 70 wt % to about 80 wt %, such as about 75 wt % to about 80 wt %, or 70, 71, 72, 73, 74, 75, 76, 77, 78, 79, or 80 wt %, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated. In some embodiments, the starch can include amylose in an amount that is from about 20 wt % to about 30 wt %, such as about 20 wt % to about 25 wt %, or 20, 21, 22, 23, 24, 25, 26, 27, 28, 29, or 30 wt %, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

Combinations of bio-additives, in suitable proportions, can be utilized with embodiments described herein.

UF resin compositions described herein can include a polymer that has rheology enhancing properties, strength enhancing properties, or combinations thereof, such as rheology enhancing polymers, strength enhancing polymers, or combinations thereof. Any suitable rheology enhancing polymer and/or strength enhancing polymer can be utilized. The polymer having rheology enhancing properties, strength enhancing properties, or combinations thereof, when used is different from the bio-additive utilized.

In some embodiments, rheology and/or strength enhancing polymers can include anionic, cationic, non-ionic, and zwitterionic polymers. Rheology and/or strength enhancing polymers can include a sulfonated polymer. Sulfonated polymers can be a material of biological origin, derived from a material of biological origin, or partially or fully synthetic. The sulfonated polymer, when used, is different from the bio-additive utilized.

Sulfonated polymers include a lignosulfonic acid, a salt of a lignosulfonic acid (a lignosulfonate), or combinations thereof.

Salts of lignosulfonic acids include lignosulfonic acid and a cation. Useful cations for lignosulfonic acid can be monoatomic or polyatomic. Monoatomic cations can include an alkali metal (for example, Li, Na, K, Rb, and Cs), an alkaline earth metal (for example, Be, Mg, Ca, Sr, and Ba), a transition metal (Fe, Zn, Mn), or combinations thereof. Polyatomic cations can include such as ammonium (NR₄⁺, wherein each R is independently H or hydrocarbyl (for example, an alkyl)), pyridinium, phosphonium (NR₄⁺, wherein each R is independently H or hydrocarbyl (for example, an alkyl)), pyrilium (C₅H₅⁺), guanidinium (C(NH₂)₃⁺) or combinations thereof, among others. Illustrative, but non-limiting, examples of salts of lignosulfonic acid include sodium lignosulfonate, ammonium lignosulfonate, magnesium lignosulfonate, calcium lignosulfonate, or combinations thereof. The lignosulfonic acid, a salt of a lignosulfonic acid, or combinations thereof can be used in liquid form, powder form, or both. A non-limiting example of sodium lignosulfonate includes Borresperse NA 890L (Borregaard).

Besides lignosulfonates, illustrative, but non-limiting, examples of sulfonated polymers include: a sulfonated naphthalene formaldehyde polymer, a sulfonated acetone-formaldehyde polymer, a sulfonated melamine formaldehyde polymer, a sulfonated urea formaldehyde polymer, a derivative thereof, a salt thereof, or combinations thereof.

In a solution or suspension, the salt(s) may exist as one or more ions depending on, for example, the solvent. For example, one or more anions (for example, lignosulfonic acid) and one or more cations (for example, Na⁺, NR₄⁺, Ca₂⁺, Mg²⁺, et cetera) may exist in the solution or suspension.

Combinations of rheology and/or strength enhancing polymers, in suitable proportions, can be utilized with embodiments described herein.

UF resin compositions described herein can include methylated melamine-formaldehyde (MMF) crosslinkers. Relative to MMF resins, MMF crosslinkers can enable superior cure properties, improved stability, preferable reactivity with bio-additives or other components of UF resin compositions, among other properties. Here, for example, methylation can enable a superior cross-linked network of, e.g., bio-additives and/or other components in the UF resin compositions. The superior cross-linked network can lead to UF resin compositions having, for example, improved storage stability and improved water stability. MMF crosslinkers are also referred to herein as MMF crosslinkers.

In some embodiments, a molar ratio of formaldehyde to melamine (F:M) in the MMF crosslinker can be from about 1:1 to about 10:1, such as from about 1.5:1 to about 6:1, such as from about 2:3, or a molar ratio (F:M) in the MMF crosslinker can be 1:1, 1.5:1, 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, or 10:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other molar ratios (F:M) in the MMF crosslinker are contemplated.

In some embodiments, a molar ratio of methyl group to melamine (MG:M) in the MMF crosslinker can be from about 1:1 to about 6:1, such as from about 1.5:1 to about 5.5:1, such as from about 2:3, or a molar ratio (MG:M) in the MMF crosslinker can be 1:1, 1.5:1, 2:1, 2.5:1, 3:1, 3.5:1, 4:1, 4.5:1, 5:1, 5.5:1, or 6:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other molar ratios (MG:M) in the MMF crosslinker are contemplated.

Examples of MMF crosslinkers include, but are not limited to, trimethoxymethylmelamine and hexamethoxymethylmelamine (Astro Mel NW-3A or Astro Mel 400 commercially available from Hexion Inc.).

Combinations of MMF crosslinkers, in suitable proportions, can be utilized with embodiments described herein.

The MMF crosslinker can serve to, for example, crosslink one or more components of the UF resin composition, such as crosslinking a liquid UF resin (or component thereof) to itself, crosslinking a liquid UF resin (or component thereof) with another liquid UF resin (or component thereof), crosslinking a bio-additive to itself, crosslinking a bio-additive with another bio-additive, crosslinking a polymer having strength- and/or rheological-enhancing properties with itself, crosslinking a polymer having strength- and/or rheological-enhancing properties with a different polymer having strength- and/or rheological-enhancing properties, crosslinking a liquid UF resin (or component thereof) to a bio-additive, crosslinking a liquid UF resin (or component thereof) to a polymer having strength- and/or rheological-enhancing properties, crosslinking a bio-additive with a polymer having strength- and/or rheological-enhancing properties, among other crosslinking.

As described above, UF resin compositions of the present disclosure can comprise, consist essentially of, or consist of a liquid UF resin, a bio-additive, and one or more optional components. The one or more optional components can include a modifier (such as a rheology enhancing polymer, a strength enhancing polymer, or combinations thereof, or the modifier can have both rheology and strength enhancing properties), a MMF crosslinker, or combinations thereof, among other additives.

A total wt % of the UF resin composition does not exceed 100 wt % and is based on the amount of liquid UF resin, the amount of bio-additive, and the amount of one or more optional components.

A total amount of liquid UF resin(s) in UF resin compositions of the present disclosure can be from about 20 wt % to about 95 wt %, such as from about 30 wt % to about 90 wt %, such as from about 40 wt % to about 85 wt % based on the total wt % of the UF resin composition. In some embodiments, a total amount (wt %) of liquid UF resin(s) in a UF resin composition described herein, based on the total wt % of the UF resin composition, can be 20. 25, 30, 35, 40, 45, 50, 53, 55, 60, 63, 65, 70, 73, 75, 80, 85, 90, 91, 92, 93, 94, 95, 96, 97, 98, 99, 99.5, 99.9, 99.99, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

Liquid UF resins are made from formaldehyde and urea. Formaldehyde may be added in stages, urea may be added in stages, or both may be added in stages. A molar ratio of total formaldehyde to total urea in a liquid UF resin of UF resin compositions described herein can be about 0.5:1 or more, 3:1 or less, or combinations thereof, such as from about 0.5:1 to about 3:1, such as from about 0.7:1 to 2.4:1, such as from about 1:1 to 2.1:1. In at least one embodiment, a molar ratio of total formaldehyde to total urea in a liquid UF resin of UF resin compositions described herein can be 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3:1, 3.1:1, 3.2:1, 3.3:1, 3.4:1, 3.5:1, 3.6:1, 3.7:1, 3.8:1, 3.9:1, or 4:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated

A total amount of bio-additive(s) in UF resin compositions of the present disclosure can be from about 0.01 wt % to about 10 wt %, or from about 0.01 wt % to about 7 wt %, or from about 0.5 wt % to about 9 wt %, or from about 0.1 wt % to about 4 wt %, or from about 1 wt % to about 5 wt % based on the total wt % of the UF resin composition. In some embodiments, a total amount (wt %) of bio-additive(s) in a UF resin composition described herein, based on the total wt % of the UF resin composition, can be 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.2, 1.3, 1.4, 1.5, 2, 2.5, 3, 3.5, 4, 4.5, 5, 5.5, 6, 6.5, 7, 7.5, 8, 8.5, 9, 9.5, or 10, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

In at least one embodiment, a total amount of bio-additive(s) in UF resin compositions of the present disclosure can be greater than 0 wt %, 1 wt % or less, or combinations thereof, such as from about 0.05 wt % to about 1 wt %, from about 0.1 wt % to about 0.095, such as from about 0.5 wt % to about 0.9 wt %. In some embodiments, a total amount (wt %) of bio-additive(s) in a UF resin composition described herein, based on the total wt % of the UF resin composition, can be 0.01, 0.03, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

The inventors have found that use of high amounts of bio-additive in a UF resin composition, such as greater than 1 wt %, can lead to a UF resin composition that may not stable in terms of, for example, storage stability and/or white-water stability. In addition, when such a UF resin composition (having greater than 1 wt % bio-additive) is mixed with a substrate (such as glass fibers), the UF resin composition can precipitate out, leading to poor performance properties when used in an article of manufacture such as a glass mat. Accordingly, embodiments described herein can include compositions where the amount of bio-additive is 1 wt % or less, preventing the stability and precipitation problems.

The inventors have also found that higher amounts of bio-additive in a UF resin composition, such as greater than 1 wt %, can be used when the UF resin composition includes a sulfonated polymer, a MMF crosslinker, or combinations thereof. The sulfonated polymer (which is a rheology- and/or strength-enhancing polymer) can act to disperse the higher amount of bio-additive in the UF resin composition, and the MMF crosslinker can serve to stabilize the higher amount of bio-additive in the UF resin composition. This dispersion and/or stabilization can enable the use of greater than 1 wt % of bio-additive while still achieving desired performance in terms of, for example, stability and performance properties, as well as no precipitation. Accordingly, embodiments described herein can include compositions where the amount of bio-additive is greater than 1 wt % when the compositions also include a sulfonated polymer, an MMF crosslinker, or combinations thereof, preventing the stability and precipitation problems associated with higher amounts of bio-additive.

A total amount of sulfonated polymers (for example, rheology enhancing polymer(s), strength enhancing polymer(s), or both) in UF resin compositions of the present disclosure can be from about 0.1 wt % to about 20 wt %, such as from about 0.2 wt % to about 15 wt %, such as from about 0.3 wt % to about 10 wt % based on the total wt % of the UF resin composition. In some embodiments, a total amount (wt %) of rheology enhancing polymer(s), strength enhancing polymer(s), or both in a UF resin composition described herein, based on the total wt % of the UF resin composition, can be 0.1, 0.5, 1.0, 1.5, 2.5, 3, 4, 5, 6, 7, 8, 9, 10, 11, 12, 13, 14, 15, 16, 17, 18, 19, or 20, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated. As described above, a polymer such as a lignosulfonate includes both rheology enhancing properties and strength enhancing properties.

A total amount of MMF crosslinker(s) in UF resin compositions of the present disclosure can be from about 0.05 wt % to about 20 wt %, such as from about 0.1 wt % to about 15 wt %, such as from about 0.3 wt % to about 10 wt % based on the total wt % of the UF resin composition. In some embodiments, a total amount (wt %) of MMF crosslinker(s) in a UF resin composition described herein, based on the total wt % of the UF resin composition, can be 0.1, 0.5, 1.0, 1.5, 2.5, 3, 4, 5, 6, 7, 8, 9, 10, 11, 12, 13, 14, 15, 16, 17, 18, 19, or 20, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

Besides the liquid UF resin, the bio-additives, and the one or more optional components (e.g., MMF crosslinker(s), rheology enhancing polymer(s), strength enhancing polymer(s), or combinations thereof), UF resin compositions described herein can optionally include additives. Illustrative, but non-limiting, examples of optional additives can include, or are selected from the group consisting of a catalyst, an anti-foam agent, an anti-settling agent, an air-release agent, a pigment, an ultraviolet stabilizer (UV stabilizer), or combinations thereof. The additives can be used to aid in processing, among other uses.

In some embodiments, a total amount of additive(s) in UF resin compositions described herein can be from about 0 wt % to about 10 wt %, such as from about 0.01 wt % to about 10 wt %, such as from about 0.1 wt % to about 9 wt %, such as from about 0.5 wt % to about 7 wt %, such as from about 1 wt % to about 5 wt %, such as from about 2 wt % to about 3 wt %, based on the total wt % of the UF resin compositions. In at least one embodiment, the total amount (in wt %) of additives(s) in a UF resin composition, based on the total wt % of the UF resin composition, can be 0, 0.01, 0.03, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

The catalyst additive can be used to control curing of the resin. Any suitable catalyst additive can be utilized, such as acid-based catalysts. For example, Q55BC acid-based catalyst (commercially available from Hexion Inc.) can be used.

### Methods

Embodiments of the present disclosure generally relate to methods of forming a urea-formaldehyde resin composition. As described above, UF resin compositions of the present disclosure can comprise, consist essentially of, or consist of a liquid urea-formaldehyde resin, a bio-additive, and one or more optional components. The one or more optional components can include a modifier (such as rheology enhancing polymers, strength enhancing polymers, or combinations thereof), a MMF crosslinker, or combinations thereof, among other additives.

Urea-formaldehyde resin compositions described herein can be prepared according to any suitable method, such as Method A, Method B, and Method C, described below.

### Method A

Method A can be utilized to prepare a UF resin composition comprising, consisting essentially of, or consisting of a liquid UF resin and a bio-additive, among other optional components. Method A can include a two-stage reaction to form the resin composition: a UF polycondensation from the reaction between urea and formaldehyde and bio-additives reacted-in with mixture comprising the UF polymers.

A formaldehyde solution (53% in water) can be used for the resin syntheses, though other formaldehyde solutions (e.g., formalin) can be used such as those described above. A urea-formaldehyde concentrate (UFC) can be used for the reaction. The UFC can include 60 wt % formaldehyde and 25 wt % urea.

Urea can be added in two parts, a first amount of urea (U1) and a second amount of urea (U2).

In the first operation of Method A, about 53% formaldehyde and water (optional) can be charged into a reactor. The pH can be adjusted to a value that is from about 7 to about 9, such as from about 7.5 to about 8.5, or to a pH of 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, or 9, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other values are contemplated. The pH can be adjusted using any suitable pH adjusting agent such as triethanolamine (TEA); aqueous sodium hydroxide (NaOH), such as 50% aqueous NaOH; aqueous formic acid, such as 10% aqueous formic acid; or combinations thereof. During the first operation, aqueous ammonia can be added. Ammonia can be utilized to improve the stability of the liquid UF resin and the water dilution characteristics which can be useful for, e.g., glass mat fabrication. In some embodiments, 30% aqueous ammonia can be added.

The first operation can further include adding a first amount of urea (U1) to the reactor and raising the temperature to a temperature of about 90° C. to about 107° C., such as from about 95° C. to about 102° C., or from about 99° C. to about 102° C., or to a temperature of 90, 91, 92, 93, 94, 95, 96, 97, 98, 99, 100, 101, 102, 103, 104, 105, 106, or 107° C., or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other temperatures are contemplated. The mixture comprising the first amount of urea and formaldehyde can be held at the selected temperature for any suitable period such as from about 1 minute to about 60 minutes, such as from about 5 minutes to about 40 minutes, such as from about 10 minutes to about 25 minutes, or from about 20 minutes to about 30 minutes. Any of the foregoing numbers can be used singly to describe an open-ended range or in combination to describe a close-ended range. Other periods are contemplated. Additionally or alternatively, and in some embodiments, the mixture comprising formaldehyde and urea can be held at the selected temperature until the pH of the mixture stabilizes.

During the first operation, the urea and formaldehyde are present at a first molar ratio (a reaction molar ratio) of formaldehyde to urea (F:U1) that can be from about 2:1 to about 4:1, such as from about 2.4:1 to about 3.5:1, or a first molar ratio (F:U1) that can be 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, 3.5:1, 3.6:1, 3.7:1, 3.8:1, 3.9:1, or 4:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other first (or reaction) molar ratios (F:U1) for the first operation are contemplated.

If ammonia (A) is utilized during the first operation, a reaction molar ratio of formaldehyde to a total amount of first urea and ammonia (F:(U1+A)) can be from about 1.5:1 to about 3.5:1, such as from about 1.8:1 to about 3:1, or a reaction molar ratio (F:(U1+A)) that can be 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, or 3.5:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other reaction molar ratios (F:(U1+A)) for the first operation are contemplated. When ammonia is utilized, reaction of the ammonia, formaldehyde, and urea forms triazones and optionally derivatives.

When ammonia is used during the first operation, the elevated temperatures described above for the mixture comprising urea and formaldehyde can be utilized. The mixture comprising ammonia, formaldehyde, and urea can be held at such temperatures for any suitable period such as from about 5 minute to about 60 minutes, such as from about 5 minutes to about 40 minutes, or from about 20 minutes to about 50 minutes, or from about 20 minutes to about 30 minutes. Any of the foregoing numbers can be used singly to describe an open-ended range or in combination to describe a close-ended range. Other periods are contemplated. Additionally or alternatively, and in some embodiments, the mixture comprising ammonia, formaldehyde, and urea, can be held at the selected temperature until the pH of the mixture stabilizes.

The first operation can include stirring, mixing, and/or agitating the components present in the reactor by using any suitable devices. Suitable devices can include a mechanical stirrer (for example, an overhead stirrer), a magnetic stirrer (for example, placing a magnetic stir bar in the vessel above a magnetic stirrer), or other suitable devices. For example, a stirrer (having a blade or propeller) can be rotated by receiving rotational power from a stirring motor to stir the one or more components at suitable rotation speeds. The first operation can include utilizing a non-reactive gas, such as N₂. Ar, or combinations thereof. For example, a non-reactive gas can be introduced to the components present in the reactor to, for example, degas various components or otherwise remove unwanted gases (for example, oxygen) from the mixture.

Selection of, for example, the first (or reaction) molar ratio (F:U1 and/or F:(U1+A)), temperature, period, pH, or combinations thereof during the first operation can impact, for example, the resulting mixture used for the second operation, the polymerization in the second operation, as well as the final UF resin composition. For example, selection of molar ratios (e.g., F:U1) outside of those described herein can result in more free formaldehyde present in the final UF resin composition formed from Method A.

Method A further includes a second operation (a reaction stage) that includes a urea-formaldehyde polymerization or polycondensation under acidic conditions. In the second operation, the pH of the mixture resulting from the first operation can be lowered to a pH value that is from about 4 to about 6, such as from about 4.5 to about 5.5, such as from about 4.8 to about 5, or to a pH of 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, or 6, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other pH values for the second operation are contemplated. The pH can be adjusted using any suitable pH adjusting agent such as aqueous sulfuric acid, such as about 6% aqueous sulfuric acid; TEA; or combinations thereof. During this reaction stage, a reaction temperature be selected to be, for example, an elevated temperature or range described above for the first operation (e.g., from about 90° C. to about 107° C., such as from about 95° C. to about 100° C., among other temperatures). Different degrees of polymerization can be selected based on, for example, a desired target end viscosity, the F:U1 molar ratio, the pH, or combinations thereof.

In some embodiments, the second operation can be ceased at a target Gardner-Holt (G-H) viscosity by increasing the pH of the mixture to a pH of about 7 to about 9, such as from about 7.5 to about 8.5 using any suitable pH adjusting agent such as: TEA; aqueous sodium hydroxide (NaOH), such as 50% aqueous NaOH; or combinations thereof. In some embodiments, the target G-H viscosity can be a value or range that is from about “A” to about “W”, such as from about “B” to about “T”, such as from about “C” to about “R”. G-H viscosity is determined by ASTM D1545, viscosity of transparent liquids by Bubble time method. After reaching the target G-H viscosity, a vacuum distillation can be performed to increase the solids level of the mixture. Here, the vacuum distillation can remove, for example, water, among other components in the mixture resulting from the second operation.

The second operation can include stirring, mixing, and/or agitating the components present in the reactor by using any suitable devices such as those devices described above, such as a mechanical stirrer, a magnetic stirrer, or other suitable devices. The second operation can include utilizing a non-reactive gas, such as N₂. Ar, or combinations thereof. For example, a non-reactive gas can be introduced to the components present in the reactor to, for example, degas various components or otherwise remove unwanted gases (for example, oxygen) from the mixture.

Selection of, for example, the first (or reaction) molar ratio (F:U1 and/or F:(U1+A)), temperature, period, pH, or combinations thereof during the second operation can impact, for example, the polymerization in the second operation, the viscosity of the mixture resulting from the second operation, as well as the final UF resin composition. For example, selection of molar ratios (e.g., F:U1) and the pH can affect the amount of polymerization, which in turn, can affect the viscosity of the mixture and can affect the amount of free formaldehyde present in the final UF resin composition formed from Method A.

Method A further includes a third operation (a reaction stage), which includes bio-additives reacted-in with the mixture comprising the UF polymers. During the third operation, the mixture resulting from the second operation can be first cooled to a reaction temperature of about 70° C. to about 95° C., such as from about 75° C. to about 90° C., or about 80° C. to about 90° C., or to a temperature of 75, 76, 77, 78, 79, 80, 81, 82, 83, 84, 85, 86, 87, 88, 89, 90, 91, 92, 93, 94, or 95° C., or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other temperatures are contemplated. This temperature can be referred to as the reaction temperature of the third operation.

During the third operation, a reaction pH can be selected. Here, the pH can be adjusted to a value that is from about 7 to about 9, such as from about 7.5 to about 8.5, or to a pH of 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, or 9, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other values are contemplated. This pH can be referred to as the reaction pH of the third operation. The pH can be adjusted using any suitable pH adjusting agent: such as TEA; aqueous sodium hydroxide (NaOH), such as 50% aqueous NaOH; aqueous formic acid, such as 10% aqueous formic acid; or combinations thereof.

During the third operation a bio-additive (or a mixture comprising a bio-additive in any suitable liquid such as water) can be added to the reactor and reacted-in with the UF polymers. The amount of bio-additive added to the reactor can be chosen such that the UF resin composition formed from Method A comprises a certain amount of bio-additive, such as from about 0.01 wt % to about 10 wt %, such as from about 0.01 wt % to about 7 wt %, such as from about 0.1 wt % to about 4 wt % of the bio-additive based on a total wt % of the UF resin composition. Other amounts are contemplated such as those described above with respect to the urea-formaldehyde resin compositions.

After the bio-additive is added, the mixture can be held at the selected reaction temperature, and selected reaction pH for any suitable reaction period such as from about 1 minute to about 60 minutes, such as from about 5 minutes to about 60 minutes, such as from about 5 minutes to about 40 minutes, or from about 15 minutes to about 50 minutes, or from about 10 minutes to about 25 minutes, or from about 20 minutes to about 30 minutes. Any of the foregoing numbers can be used singly to describe an open-ended range or in combination to describe a close-ended range. Other periods are contemplated. Additionally, or alternatively, the third operation can be ceased once a desired reaction viscosity (a G-H viscosity) is achieved. Here, and in some embodiments, the target G-H viscosity can be a value or range that is from about “B” to about “Z”, such as from about “C” to about “W”, such as from about “D” to about “T”.

In some embodiments, the amount of bio-additive added to the UF polymers is selected increase the viscosity at an increasing rate over time. The higher amount of bio-additive added during the third operation, can result in a faster rate of viscosity increase.

During the third operation, the bio-additive can disperse in the liquid UF resins and can denature (and/or untangle). Upon denaturing and/or untangling, at least a portion of the bio-additive can swell and hold water, or combinations thereof. Depending on, for example, the reaction period, the reaction temperature, and/or the reaction pH, the dissolution of the bio-additive in the mixture can be different. In addition, selection of, for example, the proper reaction period, the proper reaction temperature, and/or the proper reaction pH can lead to incorporating the bio-additive with the UF polymers by hydrogen bonding and can improve the storage stability of the final resin without retrogradation of the bio-additive. When a proper reaction is not employed, the final resin UF resin composition can have poor properties such as very high viscosity or a phase-separation.

As an example, and when a starch (or starch derivative is employed, such as cationic starch), the starch can disperse in the liquid UF resins and denature (or untangle). At least a portion of the starch can then swell during the third operation. When the starch network swells, the viscosity of the resin increases. This swelling and viscosity increase may be due to the chemical composition of starch (e.g., containing about 20 wt % to about 25 wt % amylose and about 75 wt % to about 80 wt % amylopectin) and its insolubility at lower temperatures. Amylose has a linear and helical molecular structure and is a smaller molecular weight molecule, whereas amylopectin is branched structure and has higher molecular weight. As a result, the dissolution of the starch can be different dependent upon, for example, the reaction period and reaction temperature. When, for example, the reaction temperature, amount of bio-additive, reaction pH, reaction period, or combinations thereof, among other factors are not proper, the final UF resin composition comprising the liquid UF resin and the starch can have poor performance in terms of, for example, too high of viscosity or phase separation. Alternatively, when, for example, a proper reaction period, a proper reaction temperature, a proper reaction pH, a proper amount of bio-additive, or combinations thereof are employed (among other factors), the final UF resin composition comprising the liquid UF resin and the bio-additive can have improved performance in terms of, for example, desired viscosity and no phase separation.

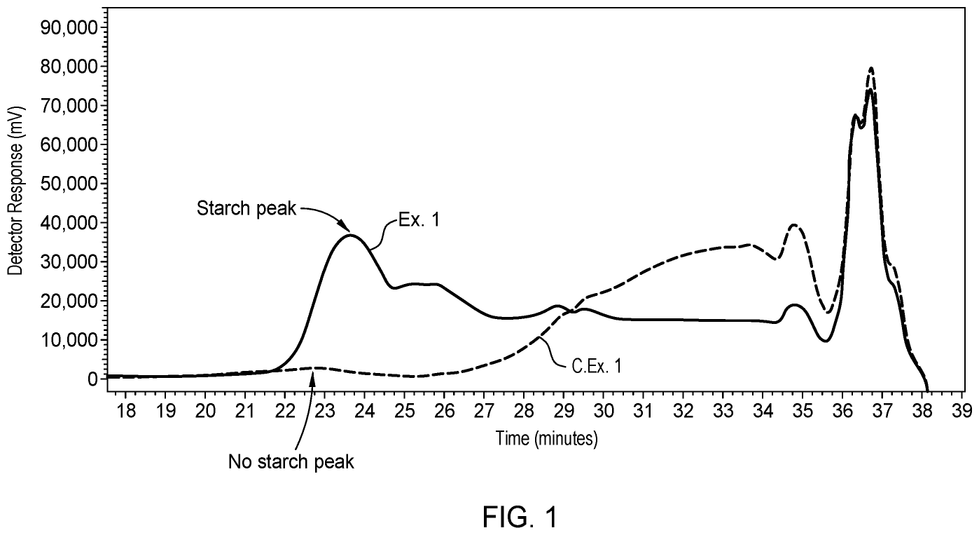

Exemplary gel permeation chromatography (GPC) data for two urea-formaldehyde (UF) resin compositions comprising starch made using different reaction methods—an “up-front synthesis” and a “middle synthesis”—are shown in FIG. 1. The up-front synthesis is shown as a dashed line and the middle synthesis is shown as a solid line. Although both GPC contain starch, there is a significant difference in the data. When the starch is reacted-in at the beginning of the synthesis (up-front synthesis), the GPC lacks a starch molecular weight (MW) peak as all of the starch dissolves in the liquid UF resin. In contrast, when the starch is reacted-in according to embodiments of the present disclosure (for example, at a mid-point of the synthesis (such as the third operation)), a starch MW peak is present, indicating that the starch did not dissolve in the liquid UF resin. Overall, FIG. 1 illustrates that methods described herein can enable proper production of bio-additive modified UF resin compositions. Use of the middle synthesis can enable the starch to untangle and swell properly such that the resultant bio-additive modified UF resin composition has superior performance such as desired viscosity, no phase separation, and good mechanical properties relative to bio-additive modified UF resin compositions made with improper synthesis methods.

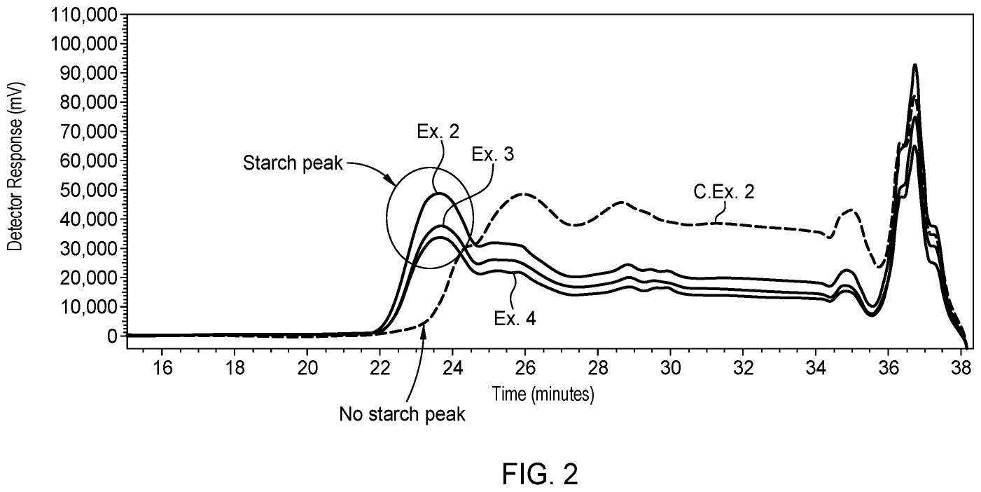

FIG. 2 shows exemplary GPC data for three example UF resin compositions comprising varying amounts of starch and a control UF resin according to at least one embodiment of the present disclosure. The example UF resin compositions comprising starch are shown as solid lines, and the control UF resin (containing no starch) is shown as a dashed line. The GPC data of the example UF resin compositions shows the starch MW peak when the starch is reacted-in according to embodiments described herein, while the control did not have such a peak. FIG. 2 also indicates that different amounts of starch utilized can affect the peak heights.

Similar results can apply to other bio-additives such that methods of the present disclosure can be used with other bio-additives for forming UF resin compositions. Overall, FIGS. 1 and 2 illustrate that methods of the present disclosure enable the bio-additives (such as starch) to have, for example, the proper molecular weight modification of the UF resin compositions, which can provide better strength properties of the glass-mats. In turn, this can affect properties of the UF resin compositions such as the rheology as well as strength properties of articles that include UF resin compositions (such as glass mats). If the proper molecular weight of the starch is not there, the UF resin composition does not improve the strength properties.

Bio-additives besides starch can be utilized such as those described above with respect to the urea-formaldehyde resin compositions. Relative to conventional technologies, use of the bio-additive in UF resin compositions described herein can improve the rheology, can improve its adhesion to substrates (such as resin fibers), can result in better resin better resin pick up on a glass-fiber surface, can improve a mat's wet-web strength, and can improve strength properties of a glass mat.

The third operation can include stirring, mixing, and/or agitating the components present in the reactor by using any suitable devices such as those devices described above, such as a mechanical stirrer, a magnetic stirrer, or other suitable devices. The third operation can include utilizing a non-reactive gas, such as N₂. Ar, or combinations thereof. For example, a non-reactive gas can be introduced to the components present in the reactor to, for example, degas various components or otherwise remove unwanted gases (for example, oxygen) from the mixture.

Method A further includes a fourth operation (a reaction stage) that includes adding the second amount of urea and an optional additive. The fourth operation can include first placing the mixture resulting from the third operation at a temperature of about 50° C. to about 70° C., such as from about 55° C. to about 65° C. and adding the second amount of urea (U2) to the mixture.

The resultant mixture can then be placed at a reaction temperature of about 40° C. to about 60° C., such as from about 45° C. to about 55° C., or about 40° C. to about 45° C., or at a temperature of 40, 41, 42, 43, 44, 45, 46, 47, 48, 49, 50, 51, 52, 53, 54, 55, 56, 57, 58, 59, or 60° C., or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other temperatures are contemplated. This reaction temperature can be referred to as the reaction temperature of the fourth operation.

The second amount of urea (U2) is then added, and amounts are discussed further below. After the urea is added, the pH of the mixture can be adjusted to a reaction pH that is from about 7 to about 9, such as from about 7.5 to about 8.5, or to a pH of 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, or 9, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other values are contemplated. This reaction pH can be referred to as the reaction pH of the fourth operation. The pH can be adjusted using any suitable pH adjusting agent such as TEA; aqueous formic acid, such as 10% aqueous formic acid; or combinations thereof. The mixture can be held at the reaction pH and the reaction temperature for any suitable reaction period such as from about 1 minute to about 60 minutes, such as from about 5 minutes to about 60 minutes, such as from about 5 minutes to about 40 minutes, or from about 5 minutes to about 15 minutes, or from about 15 minutes to about 50 minutes, or from about 10 minutes to about 25 minutes, or from about 20 minutes to about 30 minutes. Any of the foregoing numbers can be used singly to describe an open-ended range or in combination to describe a close-ended range. Other periods are contemplated. This reaction period can be referred to as the reaction period of the fourth operation.

During the fourth operation, some of the second amount of urea can react with free formaldehyde present in the reaction mixture to form hydroxymethylurcas. In some embodiments, the addition of the second amount of urea and subsequent reaction with free formaldehyde can leave less than about 0.3 wt % free formaldehyde in the resin composition.

If desired, an optional additive (such as a catalyst, or other additive) can be added to the mixture during the fourth operation. A catalyst can be used to control the cure of the resin. Illustrative, but non-limiting examples of catalysts include an acid-based catalyst such as Q55BC. Any suitable amount of catalyst can be used such as from about 0 wt % to about 10 wt %, such as from about 0.05 wt % to about 8 wt %, such as from about 0.2 wt % to about 5 wt %, based on the total wt % of the UF resin composition. In at least one embodiment, the amount of catalyst in the UF resin composition, based on the total wt % of the UF resin composition, can be 0.01, 0.03, 0.05, 0.1, 0.25, 0.5, 0.75, 1, 1.2, 1.5, 2, 2.5, 3, 3.5, 4, 4.5, 5, 5.5, 6, 6.5, 7, 7.5, 8, 8.5, 9, 9.5, or 10, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

Any of the foregoing numbers can be used singly to describe an open-ended range or in combination to describe a close-ended range. Other amounts are contemplated.

When an optional additive such as a catalyst is utilized, the resulting mixture can be held at a temperature that is from about 40° C. to about 60° C., such as from about 45° C. to about 55° C., or about 40° C. to about 45° C., and held at this temperature for about 10 minutes to about 30 minutes, such as from about 15 minutes to about 25 minutes, such as from about 15 minutes to about 20 minutes or from about 20 minutes to about 25 minutes. Any of the foregoing numbers can be used singly to describe an open-ended range or in combination to describe a close-ended range.

The synthesis of the UF resin composition (a bio-additive modified UF resin composition) can be completed by cooling the mixture to about room temperature (about 20° C. to about 25° C.). The pH of the mixture can optionally be adjusted to a pH from about 7 to about 8, such as from about 7.5 to about 7.9 using a pH adjusting agent described herein (for example, TEA and/or 10% aqueous formic acid).

As described above, the fourth operation includes adding a selected second amount of urea (U2) such that the resultant mixture has a final molar ratio of the formaldehyde to a total amount of first urea and second urea (F:(U1+U2)). This final molar ratio (F:(U1+U2)) can be from about 0.7:1 to about 2.4:1, such as from about 1:1 to about 2.1:1, or can be 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other final molar ratios (F:(U1+U2)) are contemplated.

If ammonia (A) is utilized during the fourth operation, a final molar ratio of formaldehyde to a total amount of first urea, second urea, and ammonia (F:(U1+U2+A)) during the fourth operation can be from about 0.5:1 to about 2:1, such as from about 0.7:1 to about 1.8:1, or can be 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, or 2:1 or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other final molar ratios (F:(U1+U2+A)) for the fourth operation are contemplated.

The fourth operation can include stirring, mixing, and/or agitating the components present in the reactor by using any suitable devices such as those devices described above, such as a mechanical stirrer, a magnetic stirrer, or other suitable devices. The fourth operation can include utilizing a non-reactive gas, such as N₂. Ar, or combinations thereof. For example, a non-reactive gas can be introduced to the components present in the reactor to, for example, degas various components or otherwise remove unwanted gases (for example, oxygen) from the mixture.

Selection of, for example, the molar ratio (F:(U1+U2) and/or F:(U1+U2+A)), temperature, period, pH, or combinations thereof during the fourth operation can impact, for example, the properties of the resulting UF resin composition. For example, selection of molar ratios and pH can affect the amount of free formaldehyde present in the final UF resin composition formed from Method A.

Method A can be performed according to the following non-limiting procedure. The UF polymers made during the second operation (a first reaction stage) can be formed at an F:U1 molar ratio of about 2 to about 4 (or, if ammonia is used, a F:(U1+A) molar ratio of about 1.5 to about 3.5) under acidic conditions (pH of about 4 to about 6) at about 95° C. to about 100° C. Bio-additives are reacted-in during the third operation (a second reaction stage) can then be employed, in which bio-additives are added and reacted-in with the UF polymers at about 70° C. to about 95° C. for about 5 minutes to about 60 minutes or until a target viscosity was achieved. The bio-additives amount can be from about 0.01 wt % to about 7 wt %. An additional amount of urea, and optional additive) can be added after the reaction to achieve a final F:(U1+U2) molar ratio of about 0.7 to about 2.4 (or, if ammonia is used, a F:(U1+U2+A) molar ratio of about 0.5 to about 2).

### Method B

Method B can be utilized to prepare a UF resin composition comprising, consisting essentially of, or consisting of a liquid UF resin, a bio-additive, and a modifier (for example, a rheology- and/or strength-enhancing polymer), among other optional components. Method B can include a three-stage reaction to form the resin composition: a UF polycondensation from the reaction between urea and formaldehyde, bio-additives reacted-in with the mixture comprising the UF polymers, and an incorporation of rheology and/or strength enhancing polymers into the mixture. Urea can be added in two parts, a first amount of urea (U1) and a second amount of urea (U2).

In some embodiments, Method B includes five operations. The first operation, the second operation, the third operation, and the fourth operation of Method B can be the same as or similar to those first-fourth operations of Method A described above.

After the fourth operation, the fifth operation (a reaction stage) can be performed. The fifth operation can include addition of a rheology enhancing polymer, a strength enhancing polymer, or combinations thereof. In some embodiments, this polymer can be a sulfonated polymers, such as those described above. For example, sodium lignosulfonate (and/or other sulfonated polymer) can be utilized. The lignosulfonate (and/or other sulfonated polymer) can be added in powder form or liquid form). When used, the total amount of rheology and strength enhancing polymer (e.g., lignosulfonate) can be any suitable amount such as from about 0.01 wt % to about 20 wt %, such as from about 0.1 wt % to about 20 wt %, such as from about 0.3 wt % to about 10 wt %, such as from about 0.5 wt % to about 5 wt, or 0.01, 0.03, 0.05, 0.1, 0.25, 0.5, 0.75, 1, 1.2, 1.5, 2, 2.5, 3, 3.5, 4, 4.5, 5, 5.5, 6, 6.5, 7, 7.5, 8, 8.5, 9, 9.5, 10, 11, 11.5, 12, 12.5, 13, 13.5, 14, 14.5, 15, 15.5, 16, 16.5, 17, 17.5, 18, 18.5, 19, 19.5, or 20 wt %, or ranges thereof, based on the total wt % of the UF resin composition. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

After the addition, the resultant mixture can be set to a reaction temperature that is from about 40° C. to about 60° C., such as from about 45° C. to about 55° C., or about 40° C. to about 45° C., and held at this reaction temperature for a reaction period that can be from about 10 minutes to about 30 minutes, such as from about 15 minutes to about 25 minutes, such as from about 15 minutes to about 20 minutes or from about 20 minutes to about 25 minutes. Any of the foregoing numbers can be used singly to describe an open-ended range or in combination to describe a close-ended range. This reaction temperature and reaction period can be referred to as the reaction temperature of the fifth operation and reaction period of the fifth operation.

During the fifth operation, the mixture can be set to a reaction pH that is from about 7 to about 9, such as from about 7.5 to about 8.5, or to a pH of 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, or 9, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other values are contemplated. This reaction pH can be referred to as the reaction pH of the fifth operation. The pH can be adjusted using any suitable pH adjusting agent such as triethanolamine (TEA); aqueous sodium hydroxide (NaOH), such as 50% aqueous NaOH; aqueous formic acid, such as 10% aqueous formic acid; or combinations thereof.

The synthesis of the UF resin composition (a bio-additive modified UF resin composition incorporating a rheology- and/or strength-enhancing polymer) can be completed by cooling the mixture to about room temperature (about 20° C. to about 25° C.). The pH of the mixture can optionally be adjusted to a pH from about 7 to about 8, such as from about 7.5 to about 7.9 using a pH adjusting agent described herein (for example, TEA and/or 10% aqueous formic acid).

The fifth operation can include stirring, mixing, and/or agitating the components present in the reactor by using any suitable devices such as those devices described above, such as a mechanical stirrer, a magnetic stirrer, or other suitable devices. The fifth operation can include utilizing a non-reactive gas, such as N₂, Ar, or combinations thereof. For example, a non-reactive gas can be introduced to the components present in the reactor to, for example, degas various components or otherwise remove unwanted gases (for example, oxygen) from the mixture.

The use of rheology- and/or strength-enhancing polymers (such as a lignosulfonate and/or other sulfonated polymer) can improve the stability of UF resin compositions, such as the storage stability and the 3-hr white-water compatibility (an industry standard test). Relative to conventional UF compositions, the use of rheology- and/or strength-enhancing polymers can improve the rheology of the UF resin composition, improve resin pick-up, and improve wet-web strength due to better adhesion. Further, and relative to articles of manufacture incorporating conventional UF resin compositions, the rheology- and/or strength-enhancing polymers can also improve the strength properties of an article of manufacture (such as a glass mat) incorporating UF resin compositions described herein.

Method B can be performed according to the following non-limiting procedure. The UF polymers made during the second operation (a first reaction stage) can be formed at an F:U1 molar ratio of about 2 to about 4 (or, if ammonia is used, a F:(U1+A) molar ratio of about 1.5 to about 3.5) under acidic conditions (pH of about 4 to about 6) at about 95° C. to about 100° C. Bio-additives reacted-in during the third operation (a second reaction stage) can then be employed, in which bio-additives are added and reacted-in with the UF polymers at about 70° C. to about 95° C. for about 5 minutes to about 60 minutes or until a target viscosity was achieved. The bio-additives amount can be from about 0.01 wt % to about 7 wt %. An additional amount of urea, and optional additive) can be added after the reaction to achieve a final F:(U1+U2) molar ratio of about 0.7 to about 2.4 (or, if ammonia is used, a F:(U1+U2+A) molar ratio of about 0.5 to about 2). A rheology- and/or strength-enhancing polymer (about 0.1 wt % to about 20 wt %) can then be incorporated at a temperature of about 40° C. to about 60° C., a pH of about 7 to about 9, for a period of about 5 minutes to about 60 minutes.

### Method C

Method C can be utilized to prepare a UF resin composition comprising, consisting essentially of, or consisting of a liquid UF resin, a bio-additive, a modifier (for example, a rheology- and/or strength-enhancing polymer), and a MMF crosslinker, among other optional components. Method C can include a four-stage reaction to form the resin composition: a UF polycondensation from the reaction between urea and formaldehyde, bio-additives reacted-in with the mixture comprising the UF polymers, an incorporation of rheology and/or strength enhancing polymers into the mixture, and incorporation with the MMF crosslinker. Urea can be added in two parts, a first amount of urea (U1) and a second amount of urea (U2).

In some embodiments, Method B includes six operations. The first operation, the second operation, the third operation, and the fourth operation of Method C can be the same as or similar to those first-fourth operations of Method A described above. The fifth operation can be the same as or similar to the fifth operation described above with respect to Method B.

After the fifth operation, the sixth operation can be performed. The sixth operation can include addition of a methylated melamine-formaldehyde crosslinker (MMF crosslinker) such as those MMF crosslinkers described above. When used, the total amount of MMF crosslinker can be any suitable amount such as from about 0.01 wt % to about 20 wt %, such as from about 0.1 wt % to about 20 wt %, such as from about 0.2 wt % to about 10 wt %, such as from about 0.5 wt % to about 5 wt, or 0.01, 0.03, 0.05, 0.1, 0.25, 0.5, 0.75, 0.9, 1, 1.2, 1.5, 2, 2.5, 3, 3.5, 4, 4.5, 5, 5.5, 6, 6.5, 7, 7.5, 8, 8.5, 9, 9.5, 10, 11, 11.5, 12, 12.5, 13, 13.5, 14, 14.5, 15, 15.5, 16, 16.5, 17, 17.5, 18, 18.5, 19, 19.5, or 20 wt %, or ranges thereof, based on the total wt % of the UF resin composition. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

After the addition, the resultant mixture can be set to a reaction temperature that is from about 40° C. to about 60° C., such as from about 45° C. to about 55° C., or about 40° C. to about 45° C., and held at this reaction temperature for a reaction period that can be from about 10 minutes to about 30 minutes, such as from about 15 minutes to about 25 minutes, such as from about 15 minutes to about 20 minutes or from about 20 minutes to about 25 minutes. Any of the foregoing numbers can be used singly to describe an open-ended range or in combination to describe a close-ended range. This reaction temperature and reaction period can be referred to as the reaction temperature of the sixth operation and reaction period of the sixth operation.

During the sixth operation, the mixture can be set to a reaction pH that is from about 7 to about 9, such as from about 7.5 to about 8.5, or to a pH of 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, or 9, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other values are contemplated. This reaction pH can be referred to as the reaction pH of the sixth operation. The pH can be adjusted using any suitable pH adjusting agent such as triethanolamine (TEA); aqueous sodium hydroxide (NaOH), such as 50% aqueous NaOH; aqueous formic acid, such as 10% aqueous formic acid; or combinations thereof.

In some embodiments, a molar ratio of formaldehyde to melamine (F:M) in the MMF crosslinker can be from about 1:1 to about 10:1, such as from about 1.5:1 to about 6:1, such as from about 2:3, or a molar ratio (F:M) in the MMF crosslinker can be 1:1, 1.5:1, 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, or 10:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other molar ratios (F:M) in the MMF crosslinker are contemplated.

In some embodiments, a molar ratio of methyl group to melamine (MG:M) in the MMF crosslinker can be from about 1:1 to about 6:1, such as from about 1.5:1 to about 5.5:1, such as from about 2:3, or a molar ratio (MG:M) in the MMF crosslinker can be 1:1, 1.5:1, 2:1, 2.5:1, 3:1, 3.5:1, 4:1, 4.5:1, 5:1, 5.5:1, or 6:1, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other molar ratios (MG:M) in the MMF crosslinker are contemplated.

The synthesis of the UF resin composition (a bio-additive modified UF resin composition incorporating a rheology- and/or strength-enhancing polymer and a MMF crosslinker) can be completed by cooling the mixture to about room temperature (about 20° C. to about 25° C.). The pH of the mixture can optionally be adjusted to a pH from about 7 to about 8, such as from about 7.5 to about 7.9 using a pH adjusting agent described herein (for example, TEA and/or 10% aqueous formic acid).

The sixth operation can include stirring, mixing, and/or agitating the components present in the reactor by using any suitable devices such as those devices described above, such as a mechanical stirrer, a magnetic stirrer, or other suitable devices. The sixth operation can include utilizing a non-reactive gas, such as N₂, Ar, or combinations thereof. For example, a non-reactive gas can be introduced to the components present in the reactor to, for example, degas various components or otherwise remove unwanted gases (for example, oxygen) from the mixture.

Use of the MMF crosslinker can serve to, for example, improve the cure of both the liquid UF resin and the MMF crosslinker and provide a good crosslinking density between various components of the UF resin composition. Relative to conventional UF resin compositions, UF resin compositions incorporating a MMF crosslinker can exhibit better three-hour white-water compatibility and storage stability. Relative to articles of manufacture incorporating conventional UF resin compositions, the MMF crosslinker can also improve the strength properties of an article of manufacture (such as a glass mat) incorporating UF resin compositions described herein.

A non-limiting example of Method C can be performed as follows. The UF polymers made during the second operation (a first reaction stage) can be formed at an F:U1 molar ratio of about 2 to about 4 (or, if ammonia is used, a F:(U1+A) molar ratio of about 1.5 to about 3.5) under acidic conditions (pH of about 4 to about 6) at about 95° C. to about 100° C. Bio-additives reacted-in during the third operation (a second reaction stage) can then be employed, in which bio-additives are added and reacted-in with the UF polymers at about 70° C. to about 95° C. for about 5 minutes to about 60 minutes or until a target viscosity was achieved. The bio-additives amount can be from about 0.01 wt % to about 7 wt %. An additional amount of urea, and optional additive) can be added after the reaction to achieve a final F:(U1+U2) molar ratio of about 0.7 to about 2.4 (or, if ammonia is used, a F:(U1+U2+A) molar ratio of about 0.5 to about 2). A rheology- and/or strength-enhancing polymer (about 0.1 wt % to about 20 wt %) can then be incorporated at a temperature of about 40° C. to about 60° C., a pH of about 7 to about 9, for a period of about 5 minutes to about 60 minutes. MMF crosslinkers (about 0.1 wt % to about 20 wt %) can then be incorporated at a temperature or about 40° C. to about 60° C., a pH of about 7 to about 9, for a period of about 5 minutes to about 60 minutes.

Urca-formaldehyde resin compositions made according to embodiments described herein can have, for example, good 3-hour water dilution characteristics and good room temperature storage stability. In addition, and as further described below, articles of manufacture such as glass mats can be made using urea-formaldehyde resin compositions described herein. In articles, such as glass mats, urea-formaldehyde resin compositions described herein can provide, for example, very good resin pick-up on wet glass fiber mats and better wet web strength than conventional technologies. Further, use of urea-formaldehyde resin compositions described herein can be utilized to provide articles (such as glass mats) having better mechanical strength properties compared to articles made with conventional, commercially available urea-formaldehyde resin compositions. In addition, urea-formaldehyde resin compositions described herein can demonstrate better strength properties of articles (such as glass mats) than conventional, commercially available resins that include latex.

### Uses

Urea-formaldehyde resin compositions of the present composition can be utilized in various applications, for example, as casting compositions (reaction compositions), molding compositions (reaction resin compositions), as prepregs, among other applications. Urea-formaldehyde resin compositions described herein can be used as adhesives, as composites, or as coatings.

Urea-formaldehyde resin compositions described herein can be useful in preparing articles of manufacture where the urea-formaldehyde resin composition serves to, for example, bind or adhere substrates together. For example, a urea-formaldehyde resin composition can be used as a binder to adhere one or more elements together. Such a binder may be applied to various substrates which may be in the form of, for example, particles, strands, fibers, or other suitable structures to adhere the particles, strands, fibers, or other suitable structures to one another.

Urea-formaldehyde resin compositions of the present composition can be utilized in various articles of manufacture. Such articles can be useful as, for example, a panel, a siding, a sheath, a wrap, a sleeve, a mat, a roll, a wall, insulation, or the like, which can be used as a structure or installation or affixed to a structure or installation. Such structures and installations can include residential building materials and structures, commercial building materials and structures, among other structures and installations. Residential and commercial building materials and structures can include roofing, walls, floors, I-joists, underlayment, and siding.

In some embodiments, articles of the present disclosure can comprise, consist essentially of, or consist of a urea-formaldehyde resin composition described herein, a substrate, and optionally one or more additional components.

The substrates can be made of, or include, fiberglass, glass, cellulose, lignocellulose, wood, engineered composite material, metal, clay, shale, concrete, foam, polymers (including plastics, elastomers, etc.), cellular solids, or combinations thereof, among other substrates. Cellulose, lignocellulose, and wood can include, but are not limited to, solid lumber, particle board, plywood, medium density fiberboard, hardboard, parallel strand lumber, oriented strand board, strawboard, or combinations thereof, among others. Polymers include polyester, polyethylene, polyimide, aramid, nylon, rayon, carbon, cotton, etc. The substrate can be porous or non-porous. The substrate can have an open-cell structure or a closed-cell structure such as a continuous film or a film. The substrate can be flexible, moldable, or rigid. The substrate utilized can be made according to known methods. For example, cellulose, processed cellulose, lignocellulose, processed lignocellulose, wood, or processed wood can be treated with additives, such as chemicals, adhesives, or both.

Urea-formaldehyde resin compositions useful for articles are described above. As described above, the urea-formaldehyde resin composition can serve as a binder and be applied to various substrates which may be in the form of, for example, particles, strands, fibers, or other suitable structures to adhere the particles, strands, fibers, or other suitable structures to one another. Although embodiments of substrates are described with respect to fibers, it should be understood that embodiments apply to particles, strands or other suitable structures.

In some examples, articles can be made by applying a urea-formaldehyde resin composition described herein to cover at least a portion of one or more surfaces of a substrate. Any suitable method for applying the urea-formaldehyde resin composition can be performed including brush coating, spray coating, roller coating, dip coating, curtain coating, or combinations thereof. The substrate, having the urea-formaldehyde resin composition disposed thereon, can then be cured or dried by suitable methods. Curing or drying can be performed using suitable methods such as utilizing curing ovens at elevated temperatures. Heating is optional. Curing or drying can be performed at ambient conditions. Besides heating, other curing and drying methods include, but are not limited to, light, electromagnetic radiation, hot-melt, styrene-acrylics, epoxies, among others.

As a non-limiting example, urea-formaldehyde resin compositions described herein can be used for making mats such as reinforcing mats. When manufacturing reinforcing mats, the resulting mats exhibit a high degree of integrity, which is a balance of tensile strength and flexibility. The final end use or subsequent processing of any particular mat can determine the product strength targets, whether higher tensile strength, flexibility, or a balance of properties is targeted. Such mats include those useful in, for example, applications such as building construction and roofing.

While many applications commonly use glass fibers, any number of organic or inorganic fibers may be employed. The fibers used can be made of, for example, cellulose, polyester, among other substrates such as those described above.

Fibers can be either chopped strand or continuous. Continuous fibers can be extruded from bushings at the point of mat manufacture or fed to the system from bobbins, and some applications use both simultaneously. In the case of glass fibers, the glass fibers can be either sized or un-sized (untreated). Sized fibers are chemically treated, or sized, with a plurality of sizing agents to, for example, improve initial processing, improve bonding strength of the cured mats, assist subsequent processing, or to modify strength or flexibility of the final product. Such mats can be formed by both a wet-laid process and a dry-laid process. These processes can use either (or both) chopped fibers or continuous fibers.

Various substrate fibers may be employed in the production of mats, such as fibers made of, or including, fiberglass, glass, a polymer (including plastics, elastomers, etc.), cellulose, lignocellulose, wood, engineered composite material, fiberglass, glass, metal, clay, shale, concrete, foam, cellular solids, or combinations thereof. Such substrate materials are described above. A mixture of various fibers may also be employed as in the case of composite mats, such as both glass and polyester fibers in some specialty mats. In addition, specialty composite mats may include what could be considered microfibers, such as those fibers with sub-micron diameter.

Glass fiber mats, specialty mats, or composite mats can be manufactured by a wet-laid process. In general, the wet-laid process includes first forming an aqueous slurry of short-length glass fibers, under agitation in a mixing tank, then feeding the slurry onto a moving screen where the fibers enmesh themselves into a wet glass fiber mat. Excess water is separated from the wet fiber mat, for example, by vacuum. The binder composition is then applied to the mat by, for example, soaking the mat or impregnating the mat surface via curtain coater or other suitable applicator design. Excess binder composition can be removed by, for example, vacuum. The binder composition is then thermally cured in an oven, such as a forced air oven or high airflow oven, typically at a temperature that is about 200° C. or more, such as about 200° C. to about 250° C. An example of an oven suitable for curing includes a high airflow Mathis oven. The degree of mat binder cure and moisture resistance to degradation can be chosen to achieve final mat strength, asphalt coating properties, and handling/installation properties as desired to achieve industry standards for a particular glass fiber mat, specialty mat, or composite mat. The desired moisture resistance properties may vary depending upon the intended use for the mat.

Glass fiber mats, specialty mats, or composite mats can be manufactured by a dry-laid process. Dry-laid processes can include electrospinning, spun bonding, spinning islands-in-sea processes, fibrillated films, and melt blowing, among other dry laid processes. An exemplary dry laid process starts with staple fibers, which can be separated by carding into individual fibers and can then be laid together to a desired thickness by an acrodynamic or hydrodynamic process to form an unbonded fiber sheet. The unbonded fibers can then be subjected to hydraulic jets to both fibrillate and hydroentangle the fibers. Fiber entanglement and orientation can be accomplished by bushing extrusion from a melt of the fiber. The forming section can be augmented with pre-formed alternate fibers pulled from rolls or bobbins, for example, mesh scrim. Various constructions of glass mats, specialty mats, or composite mats can be dry formed, including single pass composite laminate constructions. The binder composition is then applied to the mat by, for example, soaking the mat or impregnating the mat surface via curtain coater, spray, dip pan, or other suitable applicator design.

Binder application to the formed mat is normally achieved by saturating the formed mat by curtain coater, spray, or dip pan. Excess binder composition can be removed by, for example, vacuum. The binder composition is then thermally cured in an oven at a temperature that is about 200° C. or more, such as about 200° C. to about 250° C.

As a non-limiting example, urea-formaldehyde resin compositions described herein can be used for making glass fiber insulation. Glass fiber insulation can be made according to the following non-limiting procedure. The glass can be melted and fed to a spinning disk where a spinneret extrudes the glass melt to form filaments. Depending on the type of spinneret used, either solid or hollow fibers can be formed. The filaments are then coated or sprayed with a resin binder (for example, a binder comprising, consisting essentially of, or consisting of, a urea-formaldehyde resin composition described herein). The binder is sprayed on in any suitable concentration.

The glass is cooled down and fed to an oven where the resin binder is cured. After curing, the glass is cut into suitable sizes and/or wrapped into bundles. The curable urea-formaldehyde resin composition can allow the glass mat to recover once it has been unwrapped.

After production of the articles or coated substrates at a manufacturing site, the produced articles or coated substrates can be installed at a job site. As described herein, however, urea-formaldehyde resin compositions described herein can be utilized not only at a factory, but also at the job site. For example, a urea-formaldehyde resin composition described herein can be applied to an existing structure that is already installed at a location.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### Examples

### Test Methods

Example UF resin compositions of the present disclosure were compared to comparative examples (controls). Gel Permeation Chromatography was measured according to the following Hexion Analytical GPC procedure. Resin samples were prepared for GPC analysis initially by dilution to 5 mg/mL using a solution of 0.02M ammonium acetate in dimethyl sulfoxide (DMSO). Each sample is then filtered through a 0.2 μm polytetrafluoroethylene (PTFE) filter membrane into an autosampler vial. Samples are then analyzed using an Agilent Infinity II 1260 GPC instrument equipped with a Refractive Index detector. The instrument is equipped with three size exclusion chromatography columns connected in series. The instrument column phases are: PLgel 5 μm MIXED-D, PLgel 5 μm 500 Å, PLgel 5 μm 100 Å. The instrument mobile phase is 0.02M ammonium acetate in DMSO. Instrument data for each sample is processed using Agilent GPC/SEC software. Instrument Mw and Mn calibration is performed using poly sulfonated styrene certified reference material standards.

Viscosity of the Example UF resin compositions and the control UF resin compositions was measured according to ISO 2555:2018 using a DV-1 Brookfield Viscometer (AMETEK Brookfield Company).

Surface tension (ST) and contact angle (CA) of the Example UF resin compositions and the control UF resin compositions were measured by a goniometer (Biolin Scientific, Theta Lite). The CA values were measured when a resin droplet was placed on a glass substrate (the reported CA values on the table were after 20 sec). Work of adhesion (WA) values were calculated by the Young-Dupre equation (Equation 1):

$$WA = {ST}^{*} ( Cos ( θ ) + 1 ) ) \qquad Eq . 1$$

where ST is the measured surface tension, Cos refers to cosine, and 0 is the measured contact angle in units of millinewtons/meter (mN/m).

Interfacial tension (IT) values were calculated by the Young equation (Equation 2):

$$IT = {ST}^{*} ( Cos ( θ ) ) \qquad Eq . 2$$

where SFG is the surface free energy of glass (83.4 mN/m), ST is the measured surface tension, Cos refers to cosine, and 0 is the measured contact angle. The surface tension gives the cohesion within the liquid resin.

Three-hour (3-hr) white-water dilution compatibility was measured according to the following general procedure. 1 part of resin was mixed with 10 parts of white-water (a diluted solution of Hyperfloc AF207 from Hychem, Inc.), and visually monitored for 3 hours to see whether there was any separation or precipitation.

Dry tensile strength of a glass fiber mat was measured according to the following general procedure. A cured glass mat hand sheet was cut to rectangular specimens having dimensions of 1.5 inch×4.0 inch (3.81 cm×10.16 cm). A total of eighteen specimens from three hand sheets were measured on an Instron 5566 to get an average tensile strength.

Wet tensile strength of a glass fiber mat was measured according to the following general procedure. A cured glass mat hand sheet was cut to rectangular specimens having dimensions of 1.5 inch×4.0 inch (3.81 cm×10.16 cm). A total of eighteen specimens from three hand sheets were soaked in water at 80° C. for 10 min in a Microprocess Controlled 280 water bath (Precision). Excess water in the specimen was removed with paper towel. The specimens were immediately measured on an Instron 5566.

Elmendorf Tear strength of a glass fiber mat was measured according to the following general procedure. A cured glass mat hand sheet was cut to rectangular specimens having dimensions of 2.5 inch×12.0 inch (6.35 cm×30.48 cm). Three specimens from three hand sheets were measured on Elmendorf Tearing Tester (Thwing-Albert Instrument Co.) six times to get an average measurement. Tears were analyzed via Elmendorf swing pendulum method, utilizing 3600 g pendulum and 6.35 cm×6.35 cm (2.5 inch×2.5 inch) sample size. Samples were pre-cut in the Elmendorf apparatus and tested via standard methods as noted in TAPPI (Technical Association of Pulp and Paper Industry) test methods.

LOI represents the percent of example UF resin composition or control on the glass fiber mat. A treated mat with a known weight is placed in an oven at a sufficiently high temperature to burn off the binder. After ignition, only glass fiber remains and the weight of the sample is re-measured. The % difference between these weights (the loss due to ignition) provides the % resin or binder in the treated mat. However, a calculated (theoretical) LOI method was used for this study. The theoretical LOI is calculated by a following equation:

$$LOI ( \% ) = ( ( cured mat weight - glass fiber weight ) / ( cured mat weight ) ) * 100.$$

Vacuum pull of a glass fiber mat was measured by applying a vacuum to the glass mat after a resin mix was applied to the mat to get a target theoretical LOI (20.0%+/−0.5%).

Caliper test of a glass fiber mat was measured according to the following general procedure. A cured glass mat hand sheet was cut to rectangular specimens having dimensions of 1.5 inch×4.0 inch (3.81 cm×10.16 cm). A total of twenty-one sheets from three hand sheets as one specimen were measured on a Mahr Federal dial drop indicator and an average thickness of a single sheet was obtained. Average thickness for individual sheet ranged from 35 to 40 mils (0.89 to 1.02 mm).

Retention (%) was calculated as % of wet tensile/dry tensile.

### Example GPC Data

FIG. 1 and FIG. 2 show overlay GPC data. The overlay GPC data shown in FIGS. 1 and 2 is not the molecular weight distribution but the overlay of elution volume.

FIG. 1 illustrates, for example, that the higher molecular weight region of the starch is present under the methods described herein (middle synthesis, Ex. 1), whereas the higher molecular weight region of the starch disappears when the starch was reacted-in with an up-front synthesis method (C.Ex. 1). FIG. 1 is further discussed above. GPC molecular weight data collected during the GPC runs shown in FIG. 1 is provided in Table 1A. In Table 1A, Mn is number average molecular weight of the UF resin composition and Mw is weight average molecular weight UF resin composition. The molecular weight numbers are relative and not absolute, and different GPC methods may give slightly different numbers. The different synthesis methods (middle synthesis and up-front synthesis) are described above.

TABLE 1A

| | Synthesis | Mn, | Mw, |
|---|---|---|---|
| Example | method | g/mol | g/mol |
| Ex. 1 | Middle synthesis | 120 | 11,553 |
| C. Ex. 1 | Up-front synthesis | 85 | 39,105 |

Overall, the data shown in Table 1A indicates that different molecular weights of starch can be controlled, selected, or targeted using the different synthesis methods. The middle synthesis was found to provide better UF resin compositions.

FIG. 2 illustrates the higher molecular weight peaks from the starch, whereas the control UF resin (without starch reacted-in) did not have this peak. Also, FIG. 2 illustrates that the different starch levels can affect the peak heights. FIG. 2 is further discussed above. GPC molecular weight data collected during the GPC runs shown in FIG. 2 is provided in Table 1B. In Table 1B, Mn is number average molecular weight of the UF resin composition and Mw is weight average molecular weight UF resin composition. The molecular weight numbers are relative and not absolute, and different GPC methods may give slightly different numbers.

TABLE 1B

| | UF resin | Starch, | Mn, | Mw, |
|---|---|---|---|---|
| Example | composition | wt % | g/mol | g/mol |
| C. Ex. 2 | Control A | — | 126 | 973 |
| Ex. 2 | Starch-modified UF | 1.5 | 121 | 4662 |
| | resin composition | | | |
| Ex. 3 | Starch-modified UF | 0.9 | 120 | 4072 |
| | resin composition | | | |
| Ex. 4 | Starch-modified UF | 2.0 | 121 | 4274 |
| | resin composition | | | |

In Table 1B, Examples 2-4 are examples of UF resin compositions comprising different amounts of cationic starch. Examples 2-4 were made according to embodiments described herein (middle synthesis). The comparative example (Control A) is a UF resin, Casco-Resin FG-705C (commercially available from Hexion Inc.) mixed with 8.5 wt % latex. No starch was added to Control A. Higher molecular weights can be achieved utilizing starch in UF resin composition and different molecular weights of the UF resin composition can be obtained with different amounts of starch. Different starch MW peaks (FIGS. 1 and 2) can be identified and can be different utilizing different reaction stages.

### Example Compositions

Urea-formaldehyde resin compositions of the present disclosure were made according to embodiments described herein. These Example UF resin compositions include: Example S1, Example S2, Example SL1, Example SL2, Example SL3, Example SLM1, and Example SLM2. Example S1 and Example S2 were prepared according to a non-limiting method—Example Method A—shown in Table 2. Example SL2 and Example SL3 were prepared according to a non-limiting method—Example Method B—shown in Table 2. Example SLM1 and Example SLM2 were prepared according to a non-limiting method—Example Method C—shown in Table 3.

Example SL1 is a commercially available UF resin, Casco-Resin FG-607A, with sodium lignosulfonate (about 1.2 wt %) reacted-in with the reaction mixture.

When used in Tables 2-5, TEA refers to triethanolamine, “catalyst” refers to acid-based catalyst Q55BC, ammonia refers to 30% aqueous ammonia, MMF refers to methylated melamine formaldehyde (commercially available as Astro Mel NW-3A, Hexion Inc.), NaOH is sodium hydroxide, SLS is sodium lignosulfonate (Borresperse NA 890L), starch is cationic starch (CATO 232).

TABLE 2

| Example Method A | Example Method B |
|---|---|
| (Examples S1 and S2) | (Examples SL1, SL2, and SL3) |
| 1) Charge 53% formaldehyde. | 1) Charge 53% formaldehyde. |
| 2) Adjust pH to 7.5 ± 0.5 with | 2) Adjust pH to 7.5 ± 0.5 with |
| TEA and 50% NaOH. | TEA and 50% NaOH. |
| 3) Charge ammonia and urea. | 3) Charge ammonia and urea. |
| 4) Heat to 99-102° C. and hold | 4) Heat to 99-102° C. and hold |
| for 20-30 minutes. | for 20-30 minutes. |
| 5) Adjust pH to 4.9 ± 0.1 with 6% | 5) Adjust pH to 4.9 ± 0.1 with 6% |
| aqueous sulfuric acid. | aqueous sulfuric acid. |
| 6) React to a target Gardner-Holt | 6) React to a target Gardner-Holt |
| viscosity at 95-100° C. | viscosity at 95-100° C. |
| 7) Adjust pH to 7.5 ± 0.1 with TEA and 50% | 7) Adjust pH to 7.5 ± 0.1 with TEA and 50% |
| aqueous NaOH while cooling to 85-90° C. | aqueous NaOH while cooling to 85-90° C. |
| 8) Charge a premix of starch and water. | 8) Charge a premix of starch and water. |
| 9) Mix for 20-30 minutes at 80-90° C. | 9) Mix for 20-30 minutes at 80-90° C. |
| 10) Charge urea and hold for 10 | 10) Charge urea and hold for 10 |
| minutes at 45° C. | minutes at 45° C. |
| 11) Charge catalyst and mix for | 11) Charge catalyst and mix for |
| 20 min at 40-45° C. | 20 min 40-45° C. |
| 12) Cool the batch to 25° C. | 12) Charge sodium lignosulfonate |
| and adjust pH to 7.7 ± 0.2 | and mix for 20 min at 40-45° C. |
| with either TEA or 10% aqueous | and adjust pH to 7.5 ± 0.1 with TEA |
| formic acid. | or 50% aqueous NaOH. |
| | 14) Cool the batch to 25° C. and |
| | adjust pH to 7.7 ± 0.2 with either |
| | TEA or 10% aqueous formic acid. |

TABLE 3
Example Method C (Examples SLM1 and SLM2)

1) Charge 53% formaldehyde.
2) Adjust pH to 7.5 ± 0.5 with TEA and 50% aqueous NaOH.
3) Charge ammonia and urea.
4) Heat to 99-102° C. and hold for 20-30 minutes.
5) Adjust pH to 4.9 ± 0.1 with 6% sulfuric acid.
6) React to a target “G” at 95-100° C.
7) Adjust pH to 7.5 ± 0.1 with TEA and 50% aqueous NaOH
while cooling to 85-90° C.
8) Charge a premix of starch and water.
9) Mix for 20-30 minutes at 80-90° C.
10) Charge urea and hold for 10 minutes at 45° C.
11) Charge catalyst and mix for 20 min at 40-45° C.
12) Charge sodium lignosulfonate and mix for 20 min
at 40-45° C. and adjust pH to 7.5 ± 0.1 with TEA
or 50% aqueous NaOH.
13) Charge MMF and mix for 20 min at 40-45° C.
14) Cool the batch to 25° C. and adjust pH to
7.7 ± 0.2 with either TEA or 10% aqueous
formic acid.

Table 4 shows the chemical composition of the example UF resin compositions. The values shown in Table 4 are in wt %. Vacuum distillation was applied for Examples S2 and SL3 to control the amount of final solids, removing about 1.67 wt % water and about 1.65 wt % water, respectively. No vacuum distillation was used for the other examples.

TABLE 4

| Component | S1 | S2 | SL2 | SL3 | SLM1 | SLM2 |
|---|---|---|---|---|---|---|
| Formaldehyde | 55.93 | 58.20 | 55.26 | 57.50 | 56.83 | 56.83 |
| TEA | 0.05 | 0.08 | 0.05 | 0.08 | 0.05 | 0.05 |
| 50% NaOH | 0.01 | 0.06 | 0.01 | 0.06 | 0.01 | 0.01 |
| Ammonia | 4.15 | 4.30 | 4.10 | 4.25 | 4.21 | 4.21 |
| Urea (U1) | 21.96 | 22.85 | 21.69 | 22.58 | 22.31 | 22.31 |
| Sulfuric acid | 0.13 | 0.20 | 0.13 | 0.20 | 0.13 | 0.13 |
| TEA | 0.03 | 0.08 | 0.03 | 0.08 | 0.13 | 0.13 |
| 50% NaOH | 0.01 | 0.06 | 0.01 | 0.06 | 0.01 | 0.01 |
| Vacuum distillation | — | −1.67 | — | −1.65 | — | — |
| Starch (bio-additive) | 0.87 | 0.70 | 0.88 | 0.69 | 0.6 | 0.9 |
| Water | 4.93 | 1.80 | 4.87 | 1.78 | 1.97 | 1.27 |
| Urea (U2) | 10.42 | 11.74 | 10.30 | 11.60 | 10.59 | 10.59 |
| Catalyst | 1.50 | 1.60 | 1.48 | 1.58 | 1.56 | 1.56 |
| Sodium lignosulfonate | 0.00 | 0.00 | 1.20 | 1.20 | 1.20 | 1.20 |
| MMF | 0.00 | 0.00 | 0.00 | 0.00 | 0.50 | 0.90 |
| Total | 100.00 | 100.00 | 100.00 | 100.00 | 100.00 | 100.00 |

These example UF resin compositions were compared to the following conventional UF resin compositions: Control A, Control B, and Control B-1. The latex used for the controls (comparative examples) is Rhoplex GL-720, commercially available from Dow.

Control A is a UF resin, Casco-Resin FG-705C (commercially available from Hexion Inc.) mixed with 8.5 wt % latex. Control B is a UF resin, Casco-Resin FG-607A (commercially available from Hexion Inc.). Control B-1 is control B with 13 wt % latex. Control B-2 is control B with 8.5 wt % latex.

Table 5 shows selected properties of the control UF resins and the Example UF resin compositions.

TABLE 5

| | | Viscosity | Solids | Base UF | Latex | Starch | SLS | MMF |
|---|---|---|---|---|---|---|---|---|
| Example | pH | (cPs) | (%) | resin (%) | (%) | (%) | (%) | (%) |
| Control A | 7.6 | 310 | 58.0 | 91.5 | 8.5 | 0.0 | 0.0 | 0.0 |
| Example S1 | 7.6 | 390 | 53.0 | 99.1 | 0.0 | 0.9 | 0.0 | 0.0 |
| Example S2 | 7.8 | 251 | 57.0 | 99.3 | 0.0 | 0.7 | 0.0 | 0.0 |
| Control B | 7.5 | 341 | 62.0 | 100.0 | 0.0 | 0.0 | 0.0 | 0.0 |
| Control B-1 | 7.5 | 281 | 59.8 | 87.0 | 13.0 | 0.0 | 0.0 | 0.0 |
| Example SL1 | 7.4 | 275 | 62.0 | 98.8 | 0.0 | 0.0 | 1.2 | 0.0 |
| Example SL2 | 7.4 | 294 | 56.0 | 97.9 | 0.0 | 0.9 | 1.2 | 0.0 |
| Example SL3 | 7.8 | 245 | 56.0 | 98.1 | 0.0 | 0.7 | 1.2 | 0.0 |
| Control A | 7.6 | 310 | 58.0 | 91.5 | 8.5 | 0.0 | 0.0 | 0.0 |
| Example SLM1 | 7.7 | 290 | 55.0 | 97.7 | 0.0 | 0.6 | 1.2 | 0.5 |
| Example SLM2 | 7.8 | 350 | 55.0 | 97.0 | 0.0 | 0.9 | 1.2 | 0.9 |

All Example UF resin compositions demonstrated very good storage stability. Storage stability was measured at room temperature (about 20° C. to about 25° C.) for about 2-3 weeks. Here, all Example UF resin compositions had viscosities below 600 cPs, showed no phase separation, and no precipitation, thereby indicating, for example, very good storage stability. All Example UF resin compositions passed the three-hour white-water dilution compatibility test after 7-10 days of storage (about 20° C. to about 25° C.).

Table 6 shows Goniometer data of selected control UF resin compositions and Example UF resin compositions.

TABLE 6

| | latex, | Starch, | SLS, | ST, | CA (θ), | Cos | WA, | IT, |
|---|---|---|---|---|---|---|---|---|
| Example | wt % | wt % | wt % | mN/m | degree | (θ) | mN/m | mN/m |
| Control B | 0.0 | 0.0 | 0.0 | 56.1 | 27.2 | 0.889 | 106.0 | 33.5 |
| Control B-2 | 8.5 | 0.0 | 0.0 | 47.1 | 40.9 | 0.756 | 82.7 | 47.8 |
| Example S2 | 0.0 | 0.7 | 0.0 | 55.4 | 55.1 | 0.572 | 87.1 | 51.7 |
| Example | 0.0 | 0.7 | 1.2 | 54.0 | 63.4 | 0.448 | 78.2 | 59.2 |
| SL3 | | | | | | | | |

As shown by a comparison of control B and control B-2, the latex increased the contact angle of the control UF resin compositions on the surface of the glass substrate but decreased the surface tension of the control UF resin compositions due to the lower cohesion within the liquid resin. Also, when the latex was applied, the interfacial tension between the liquid resin and the solid glass surface was increased, and the work of adhesion value decreased (compare control B and control B-2). As shown in Table 7, below, and with respect to control B and control B-1, the addition of latex increased the tensile strength but decreased the tear strength.

With respect to the Example UF resin compositions (Example S2 and Example SL3), the use of starch increased the contact angle relative to both control B and control B-2. For example, Example S2 was determined to have a contact angle of about 55.1°. The addition of sodium lignosulfonate (Example SL3) further increased the contact angle to about 63.4°. The use of starch also decreased the work of adhesion values relative to control B, from 106.0 mN/m (control B) down to about 87.1 mN/m (Example S2) and about 78.2 (Example SL3). The use of sodium lignosulfonate had the effect of lowering the work of adhesion value relative to control B-2. Here, the work of adhesion decreased from 82.7 mN/m (control B-2) to about 78.2 mN/m (Example SL3). The use of starch also increased interfacial tension values relative to the controls, when comparing control B (33.5 mN/m), control B-2 (47.8 mN/m), and Example S2 (about 51.7 mN/m). The use of sodium lignosulfonate further increased the interfacial tension value to about 59.2 mN/m. The higher contact angles of the Example UF resin compositions lead to lower work of adhesion values and higher interfacial tension values compared to the control UF resins. This is due to the fact that the surface tension values of the Example UF resin compositions were about the same as those of the control UF resins, but the higher contact angle of the Example UF resin compositions decreases the cosine value for both the work of adhesion and the interfacial tension. The higher CA values, higher IT values, and lower WA values of the Examples provided for better strength properties of the glass-mat, which is a similar trend found utilizing latex.

With respect to the glass-fiber mat investigations, the Example UF resin compositions were, in general, determined to have higher tensile strength values and better resin pick up on the glass mat than the control UF resins (Table 7, below). While not wishing to be bound to any theory, this result may be another reason that the Example UF resin compositions were determined to have better tear strength and tensile strength, whereas the controls with latex decreased the tear strength.

Overall, the Example UF resin compositions demonstrated a similar trend as the latex relative to control B—increased the contact angle, increased the interfacial tension, and decreased the work of adhesion (Table 6). The Example UF resin compositions demonstrated a similar trend as the latex when using with the glass-fibers. Here, and relative to control B, the Example UF resin compositions and the controls with latex showed better resin pick up (by the lower vacuum-pull values), and higher tensile strength than the control without latex (Table 7). Relative to control B, the controls with latex (control A and control B-1) generally showed higher tensile strength and decreased tear strength. The Example UF resin compositions showed both improved tensile strength and tear strength relative to the controls (Table 7). This result may be due to the higher surface tension and higher contact angle which lowers the work of adhesion and increases the interfacial tension.

### Example Glass-Fiber Mats

Moist glass fibers (about 6.545 grams) were treated with NALCO 8493 dispersant (about 1 mL) and water (about 40 mL). Individual binder mixes were made from the controls and Example UF resin compositions. The binder mix included the resin composition (348.4 grams), water (about 1695.3 grams), and viscosity modifier (Hyperfloc AF207, Hychem, Inc., about 188.4 grams). The viscosity modifier can be added to, for example, aid dispersion of the glass fibers when the binder mix is mixed with the glass fibers.

Glass-fiber mat hand sheets were made according to the following non-limiting procedure. The treated glass fibers and about 5 gallons of warm (about 48.9° C.) water were mixed at about 3600 rpm for about 0.5 minutes. To the resultant mixture was added about 650 mL of viscosity modifier (Hyperfloc AF207) and then mixed for about 30 seconds. The resultant mixture was then mixed for about 30 seconds with about 1.8 mL defoamer (NALCO PP03). A glass mat (12 inches×12 inches) using a Williams former. Excess liquid was then removed by vacuum. The individual binder mixes were applied to the glass mats using a Nalgene plastic bottle, which has several holes on the lid. Excess binder was vacuumed off to a target loss on ignition (LOI) using a basis weight of 1.8 lbs/100 sqft (0.8 kg/9.3 m²). Each hand sheet was then cured in a Mathis oven for about 15 seconds at a temperature of about 250° C.

Table 7 shows selected mechanical properties of the glass-fiber hand sheets. “Tear” refers to Elmendorf tear strength (in units of gram force, gf), “DT” refers to dry tensile strength (in units of pound force, lbf), “WT” refers to wet tensile strength (in units of lbf), “RT” refers to retention (in units of percent, %), LOI refers to loss on ignition (units of percent, %), “VP” refers to vacuum pull rate for a glass mat after a resin was applied (in units of revolutions per minute, rpm). The difference in properties for the Control A in study 1 and study 2 may be due to different LOI, caliper thickness.

TABLE 7

| | | Tear, | DT, | WT, | | | Caliper, | VP, |
|---|---|---|---|---|---|---|---|---|
| Study # | Example | gf | lbf | lbf | RT, % | LOI, % | in/1000 | rpm |
| Study 1 | Control A | 491 | 65 | 46 | 72 | 19.7 | 33.8 | 12.5 |
| | Example S1 | 579 | 79 | 55 | 70 | 19.6 | 32.4 | 6.0 |
| Study 2 | Control B | 531 | 63 | 46 | 73 | 19.8 | 29.1 | 14.0 |
| | Control B-1 | 403 | 74 | 51 | 69 | 19.7 | 31.3 | 12.0 |
| | Example SL1 | 464 | 69 | 50 | 72 | 20 | 32.0 | 11.0 |
| | Example SL2 | 653 | 80 | 51 | 64 | 20.1 | 30.0 | 7.0 |
| Study 3 | Control A | 452 | 70 | 51 | 73 | 19.6 | 34.0 | 15.0 |
| | Example SLM1 | 636 | 81 | 56 | 69 | 19.8 | 32.0 | 10.0 |
| | Example SLM2 | 589 | 76 | 51 | 67 | 20.5 | 34.7 | 10.0 |

Overall, the resin compositions described herein provided improved glass mats (for example, higher strength properties) over conventional technologies. For example, and as shown in Table 7, the bio-additives modified UF resin composition (Example S1), the bio-additives modified UF resin composition with rheology and strength enhancing polymers (Example SL2), and the bio-additives modified UF resin compositions with rheology and strength enhancing polymers, and MMF crosslinkers (SLM1 and SLM2) demonstrated higher dry and wet tensile strength values as well as higher tear strength values than the control with the latex when these resins were used as binders for the glass-mat application. The bio-additives modified UF resin compositions demonstrated similar caliper thickness and RT values as the control. The lower VP values of the bio-additives modified UF resin compositions indicate better resin pick-up than the controls. The low value of tear strength for Example SL1 is due to the UF resin composition not having starch.

Embodiments of the present disclosure generally relate to urea-formaldehyde resin compositions, to methods of making urea-formaldehyde resin compositions, and to uses of urea-formaldehyde resin compositions. Urea-formaldehyde resin compositions of the present disclosure can be free of latex. Overall, urea-formaldehyde resin compositions described herein can have improved storage stability and three-hour white-water dilution compatibility relative to conventional urea-formaldehyde resin compositions. UF resin compositions of the present disclosure can be more sustainable than conventional urea-formaldehyde resin compositions such as those containing latex. When used in articles of manufacture such as glass mats, urea-formaldehyde resin compositions described herein have, for example, improved mechanical properties than conventional urea-formaldehyde resin compositions such as those containing latex.

### Embodiments Listing

The present disclosure provides, among others, the following aspects, each of which can be considered as optionally including any alternate embodiments:

Clause 1. A method of forming a urea-formaldehyde resin composition, the method comprising:
heating a first mixture comprising formaldehyde and a first amount of urea, the first mixture comprising a reaction molar ratio of the formaldehyde to the first amount of urea (F:U1) of about 2:1 to about 4:1;
introducing a bio-additive with the first mixture to from a second mixture;
heating the second mixture comprising the bio-additive and the first mixture at a temperature of about 70° C. to about 95° C. while maintaining the second mixture at a pH of about 7 to about 9;
introducing a second amount of urea to the second mixture to form a third mixture, the third mixture having a final molar ratio of the formaldehyde to a total amount of first urea and second urea (F:U1+U2) of about 0.7:1 to about 2.4:1; and heating the third mixture to form a first product mixture comprising a first urea-formaldehyde resin composition.

Clause 2. The method of Clause 1, wherein the first urea-formaldehyde resin composition comprises:
about 99.99 wt % or less of a liquid urea-formaldehyde resin based on a total wt % of the first urea-formaldehyde resin composition; and/or
about 0.01 wt % to about 7 wt % of the bio-additive based on the total wt % of the first urea-formaldehyde resin composition, the total wt % of the urea-formaldehyde resin composition not to exceed 100 wt %.

Clause 3. The method of Clause 1 or Clause 2, wherein, after forming the first product mixture, the method further comprises:
introducing a sulfonated polymer with the first product mixture to form a fourth mixture; and/or
heating the fourth mixture at a temperature of about 40° C. to about 60° C. while maintaining the fourth mixture at a pH of about 7 to about 9 to form a second product mixture comprising a second urea-formaldehyde resin composition.

Clause 4. The method of Clause 3, wherein the second urea-formaldehyde resin composition comprises:
about 99.9 wt % or less of a liquid urea-formaldehyde resin based on a total wt % percent of the second urea-formaldehyde resin composition;
about 0.01 wt % to about 7 wt % of the bio-additive based on the total wt % of the second urea-formaldehyde resin composition; and/or
about 0.1 wt % to about 20 wt % of the sulfonated polymer based on the total wt % of the second urea-formaldehyde resin composition, the total wt % of the urea-formaldehyde resin composition not to exceed 100 wt %.

Clause 5. The method of Clause 3 or Clause 4, wherein after forming the second product mixture, the method further comprises:
introducing a methylated melamine-formaldehyde crosslinker with the second product mixture to form a fifth mixture; and/or
heating the fifth mixture at a temperature of about 40° C. to about 60° C. while maintaining the fifth mixture at a pH of about 7 to about 9 to form a third product mixture comprising a third urea-formaldehyde resin composition.

Clause 6. The method of Clause 5, wherein the third urea-formaldehyde resin composition comprises:
about 53 wt % to about 99.9 wt % of a liquid urea-formaldehyde resin based on a total wt % of the third urea-formaldehyde resin composition;
about 0.01 wt % to about 7 wt % of the bio-additive based on the total wt % of the third urea-formaldehyde resin composition;
about 0.1 wt % to about 20 wt % of the sulfonated polymer based on the total wt % of the third urea-formaldehyde resin composition; and/or about 0.05 wt % to about 20 wt % of the methylated melamine-formaldehyde crosslinker based on the total wt % of the third urea-formaldehyde resin composition, the total wt % of the urea-formaldehyde resin composition not to exceed 100 wt %.

Clause 7. The method of any one of Clauses 1-7, wherein:
the reaction molar ratio (F:U1) is from about 2.4:1 to about 3.5:1; and/or
the final molar ratio (F:U1+U2) is from about 0.7:1 to 2.4:1.

Clause 8. A urea-formaldehyde resin composition, comprising:
a liquid urea-formaldehyde resin; and
greater than 0 wt % and 7 wt % or less of a bio-additive based on a total wt % of the urea-formaldehyde resin composition, the bio-additive comprising starch, guar gum, xantham gum, flour, a cationic derivative thereof, an anionic derivative thereof, a zwitterionic derivative thereof, a non-ionic derivative thereof, or combinations thereof.

Clause 9. The urea-formaldehyde resin composition of Clause 8, wherein the bio-additive comprises a cationic starch.

Clause 10. The urea-formaldehyde resin composition of Clause 8 or Clause 9, further comprising a polymer having rheology enhancing properties, strength enhancing properties, or combinations thereof, the polymer being different from the bio-additive.

Clause 11. The urea-formaldehyde resin composition of Clause 10, wherein the polymer is a sulfonated polymer selected from the group consisting of a lignosulfonate, a sulfonated naphthalene formaldehyde polymer, a sulfonated acetone-formaldehyde polymer, a sulfonated melamine formaldehyde polymer, a sulfonated urea formaldehyde polymer, a derivative thereof, a salt thereof, or combinations thereof.

Clause 12. The urea-formaldehyde resin composition of any one of Clauses 8-11, further comprising a methylated melamine formaldehyde crosslinker.

Clause 13. The urea-formaldehyde resin composition of Clause 12, wherein a molar ratio of formaldehyde to melamine (F:M) in the methylated melamine formaldehyde crosslinker is from about 1:1 to about 10:1.

Clause 14. The urea-formaldehyde resin composition of Clause 12 or Clause 13, wherein a molar ratio of methyl group to melamine (MG:M) in the methylated melamine formaldehyde crosslinker is from about 1:1 to about 6:1.

Clause 15. The urea-formaldehyde resin composition of any one of Clauses 8-14, wherein the urea-formaldehyde resin composition comprises greater than 0 wt % to less than 1 wt % of the bio-additive based on the total wt % of the urea-formaldehyde resin composition, the total wt % of the urea-formaldehyde resin composition not to exceed 100 wt %.

Clause 16. The urea-formaldehyde resin composition of any one of Clauses 8-15, wherein the urea-formaldehyde resin composition comprises:
from 1 wt % to about 7 wt % of the bio-additive based on the total wt % of the urea-formaldehyde resin composition; and/or
from about 0.1 wt % to about 20 wt % of a sulfonated polymer based on the total wt % of the urea-formaldehyde resin composition, the total wt % of the urea-formaldehyde resin composition not to exceed 100 wt %, the sulfonated polymer is different from the bio-additive.

Clause 17. The urea-formaldehyde resin composition of Clause 16, the urea-formaldehyde resin composition comprises: from about 0.05 wt % to about 20 wt % of a methylated melamine-formaldehyde based on the total wt % of the urea-formaldehyde resin composition, the methylated melamine-formaldehyde for crosslinking one or more components of the urea-formaldehyde resin composition.

Clause 18. An article, comprising:
a substrate; and
a urea-formaldehyde resin composition to adhere the substrate together into the article, the urea-formaldehyde resin composition comprising:
   a liquid urea-formaldehyde resin; and
   greater than 0 wt % and 7 wt % or less of a bio-additive based on a total wt % of the urea-formaldehyde resin composition, the bio-additive comprising starch, guar gum, xantham gum, flour, a cationic derivative thereof, an anionic derivative thereof, a zwitterionic derivative thereof, a non-ionic derivative thereof, or combinations thereof.

Clause 19. The article of Clause 18, wherein the urea-formaldehyde resin composition comprises: greater than 0 wt % to less than 1 wt % of the bio-additive based on the total wt % of the urea-formaldehyde resin composition, the total wt % of the urea-formaldehyde resin composition not to exceed 100 wt %.

Clause 20. The article of Clause 18 or Clause 19, wherein
from 1 wt % to about 7 wt % of the bio-additive based on the total wt % of the urea-formaldehyde resin composition; and/or
from about 0.1 wt % to about 20 wt % of a sulfonated polymer based on the total wt % of the urea-formaldehyde resin composition, the total wt % of the urea-formaldehyde resin composition not to exceed 100 wt %, the sulfonated polymer is different from the bio-additive.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a bio-additive” includes aspects comprising one, two, or more bio-additives, unless specified to the contrary or the context clearly indicates only one bio-additive is included.

While the foregoing is directed to aspects of the present disclosure, other and further aspects of the disclosure may be devised without departing from the basic scope thereof, and the scope thereof is determined by the claims that follow.

What is claimed is:

1. A method of forming a urea-formaldehyde resin composition, the method comprising:
heating a first mixture comprising formaldehyde and a first amount of urea, the first mixture comprising a reaction molar ratio of the formaldehyde to the first amount of urea (F:U1) of about 2:1 to about 4:1;
introducing a bio-additive with the first mixture to from a second mixture;
heating the second mixture comprising the bio-additive and the first mixture at a temperature of about 70° C. to about 95° C. while maintaining the second mixture at a pH of about 7 to about 9;
introducing a second amount of urea to the second mixture to form a third mixture, the third mixture having a final molar ratio of the formaldehyde to a total amount of first urea and second urea (F:U1+U2) of about 0.7:1 to about 2.4:1; and
heating the third mixture to form a first product mixture comprising a first urea-formaldehyde resin composition.

2. The method of claim 1, wherein the first urea-formaldehyde resin composition comprises:
about 99.99 wt % or less of a liquid urea-formaldehyde resin based on a total wt % of the first urea-formaldehyde resin composition; and
about 0.01 wt % to about 7 wt % of the bio-additive based on the total wt % of the first urea-formaldehyde resin composition, the total wt % of the urea-formaldehyde resin composition not to exceed 100 wt %.

3. The method of claim 1, wherein, after forming the first product mixture, the method further comprises:
introducing a sulfonated polymer with the first product mixture to form a fourth mixture; and
heating the fourth mixture at a temperature of about 40° C. to about 60° C. while maintaining the fourth mixture at a pH of about 7 to about 9 to form a second product mixture comprising a second urea-formaldehyde resin composition.

4. The method of claim 3, wherein the second urea-formaldehyde resin composition comprises:
about 99.9 wt % or less of a liquid urea-formaldehyde resin based on a total wt % percent of the second urea-formaldehyde resin composition;
about 0.01 wt % to about 7 wt % of the bio-additive based on the total wt % of the second urea-formaldehyde resin composition; and
about 0.1 wt % to about 20 wt % of the sulfonated polymer based on the total wt % of the second urea-formaldehyde resin composition, the total wt % of the urea-formaldehyde resin composition not to exceed 100 wt %.

5. The method of claim 3, wherein after forming the second product mixture, the method further comprises:
introducing a methylated melamine-formaldehyde crosslinker with the second product mixture to form a fifth mixture; and
heating the fifth mixture at a temperature of about 40° C. to about 60° C. while maintaining the fifth mixture at a pH of about 7 to about 9 to form a third product mixture comprising a third urea-formaldehyde resin composition.

6. The method of claim 5, wherein the third urea-formaldehyde resin composition comprises:
about 53 wt % to about 99.9 wt % of a liquid urea-formaldehyde resin based on a total wt % of the third urea-formaldehyde resin composition;
about 0.01 wt % to about 7 wt % of the bio-additive based on the total wt % of the third urea-formaldehyde resin composition;
about 0.1 wt % to about 20 wt % of the sulfonated polymer based on the total wt % of the third urea-formaldehyde resin composition; and
about 0.05 wt % to about 20 wt % of the methylated melamine-formaldehyde crosslinker based on the total wt % of the third urea-formaldehyde resin composition, the total wt % of the urea-formaldehyde resin composition not to exceed 100 wt %.

7. The method of claim 1, wherein:
the reaction molar ratio (F:U1) is from about 2.4:1 to about 3.5:1; and
the final molar ratio (F:U1+U2) is from about 0.7:1 to 2.4:1.

8. A urea-formaldehyde resin composition, comprising:
a liquid urea-formaldehyde resin; and
greater than 0 wt % and 7 wt % or less of a bio-additive based on a total wt % of the urea-formaldehyde resin composition, the bio-additive comprising starch, guar gum, xantham gum, flour, a cationic derivative thereof, an anionic derivative thereof, a zwitterionic derivative thereof, a non-ionic derivative thereof, or combinations thereof.

9. The urea-formaldehyde resin composition of claim 8, wherein the bio-additive comprises a cationic starch.

10. The urea-formaldehyde resin composition of claim 8, further comprising a polymer having rheology enhancing properties, strength enhancing properties, or combinations thereof, the polymer being different from the bio-additive.

11. The urea-formaldehyde resin composition of claim 10, wherein the polymer is a sulfonated polymer selected from the group consisting of a lignosulfonate, a sulfonated naphthalene formaldehyde polymer, a sulfonated acetone-formaldehyde polymer, a sulfonated melamine formaldehyde polymer, a sulfonated urea formaldehyde polymer, a derivative thereof, a salt thereof, or combinations thereof.

12. The urea-formaldehyde resin composition of claim 8, further comprising a methylated melamine formaldehyde crosslinker.

13. The urea-formaldehyde resin composition of claim 12, wherein a molar ratio of formaldehyde to melamine (F:M) in the methylated melamine formaldehyde crosslinker is from about 1:1 to about 10:1.

14. The urea-formaldehyde resin composition of claim 12, wherein a molar ratio of methyl group to melamine (MG:M) in the methylated melamine formaldehyde crosslinker is from about 1:1 to about 6:1.

15. The urea-formaldehyde resin composition of claim 8, wherein the urea-formaldehyde resin composition comprises:
greater than 0 wt % to less than 1 wt % of the bio-additive based on the total wt % of the urea-formaldehyde resin composition, the total wt % of the urea-formaldehyde resin composition not to exceed 100 wt %.

16. The urea-formaldehyde resin composition of claim 8, wherein the urea-formaldehyde resin composition comprises:
from 1 wt % to about 7 wt % of the bio-additive based on the total wt % of the urea-formaldehyde resin composition; and
from about 0.1 wt % to about 20 wt % of a sulfonated polymer based on the total wt % of the urea-formaldehyde resin composition, the total wt % of the urea-formaldehyde resin composition not to exceed 100 wt %, the sulfonated polymer is different from the bio-additive.

17. The urea-formaldehyde resin composition of claim 16, the urea-formaldehyde resin composition comprises:
from about 0.05 wt % to about 20 wt % of a methylated melamine-formaldehyde based on the total wt % of the urea-formaldehyde resin composition, the methylated melamine-formaldehyde for crosslinking one or more components of the urea-formaldehyde resin composition.

18. An article, comprising:
a substrate; and
a urea-formaldehyde resin composition to adhere the substrate together into the article, the urea-formaldehyde resin composition comprising:
a liquid urea-formaldehyde resin; and
greater than 0 wt % and 7 wt % or less of a bio-additive based on a total wt % of the urea-formaldehyde resin composition, the bio-additive comprising starch, guar gum, xantham gum, flour, a cationic derivative thereof, an anionic derivative thereof, a zwitterionic derivative thereof, a non-ionic derivative thereof, or combinations thereof.

19. The article of claim 18, wherein the urea-formaldehyde resin composition comprises:
greater than 0 wt % to less than 1 wt % of the bio-additive based on the total wt % of the urea-formaldehyde resin composition, the total wt % of the urea-formaldehyde resin composition not to exceed 100 wt %.

20. The article of claim 18, wherein
from 1 wt % to about 7 wt % of the bio-additive based on the total wt % of the urea-formaldehyde resin composition; and
from about 0.1 wt % to about 20 wt % of a sulfonated polymer based on the total wt % of the urea-formaldehyde resin composition, the total wt % of the urea-formaldehyde resin composition not to exceed 100 wt %, the sulfonated polymer is different from the bio-additive.
